(19) United States
(12) Patent Application Publication
(10) Pub. No.: US 2022/0231519 A1
(43) Pub. Date: Jul. 21, 2022

(54) POWER SOURCE SWITCHING APPARATUS, ROBOT, METHOD, AND PROGRAM

(71) Applicant: SONY GROUP CORPORATION, Tokyo (JP)

(72) Inventor: Toshimitsu KAI, Tokyo (JP)

(73) Assignee: SONY GROUP CORPORATION, Tokyo (JP)

(21) Appl. No.: 17/609,163

(22) PCT Filed: Apr. 1, 2020
(86) PCT No.: PCT/JP2020/015087

§ 371 Date: Nov. 5, 2021

(30) Foreign Application Priority Data
Jun. 6, 2019 (JP) 2019-106559

(51) Int. Cl. H02J 7/00

(52) U.S. Cl. CPC H02J 7/0024; H02J 7/007182; H02J 7/0019

(57) ABSTRACT

An apparatus and a method capable of performing a power source switching process and a charging process without stopping electric power being supplied to a load are implemented. A configuration includes a first switch circuit provided between a first power source port and a load to be supplied with electric power; a second switch circuit provided between a second power source port and the load; and a controller that controls the first switch circuit and the second switch circuit. The controller performs, on each switch circuit, a process of switching between three states, that is, (a) an ON state, (b) an OFF state, and (c) a diode operating state, thereby performing a process of switching between power sources connected to the respective power source ports without stopping the electric power being supplied to the load. Further, the controller performs battery charging with a regenerative energy resulting from a rotation of a motor that is the load.

### TECHNICAL FIELD

The present disclosure relates to a power source switching apparatus, a robot, a method, and a program. In particular, the present disclosure relates to a power source switching apparatus, a robot, a method, and a program that enable switching of a battery (a power source) without stopping electric power being supplied.

### BACKGROUND ART

Many robots are powered by battery. A power source (battery) replacement work for such a robot is often performed after electric power supplied from a power source (a battery) to a robot system is stopped. However, such stoppage of power disrupts a task due to a loss of an actuator power source and requires reboot of the system, and thus becomes a cause of a decrease in operation efficiency of the robot.

To avoid a decrease in operation efficiency due to power source replacement, it is effective to replace a battery while electric power continues to be supplied to, for example, a load such as an actuator. As long as the electric power continues to be supplied even during battery replacement, disruption of a task and reboot of a system are not necessary, which makes it possible to reduce a decrease in operation efficiency.

It should be noted that replacing a power source without stopping electric power being supplied is referred to as live-line plugging/unplugging, active plugging/unplugging, hot swap, or the like.

Examples of a typical technology that discloses a power supply configuration using a plurality of batteries include technologies disclosed in PTL 1 (Japanese Patent Laid-Open No. Hei 9-84273) and PTL 2 (Japanese Patent Laid-Open No. 2011-115031).

PTL 1 (Japanese Patent Laid-Open No. Hei 9-84273) discloses a configuration that enables replacing of a battery without shutting off a power source, by the use of diode OR connection and a mechanical battery detection technique.

This disclosed configuration, however, has the following problems.

(a) Heat loss of a diode is large.

(b) A regenerative (charging) current cannot be recovered to a battery since a countercurrent is always prevented.

(c) The mechanical battery detection technique makes a detection unit less durable.

(d) An inrush current occurs between a power source and a smoothing capacitor.

In addition, PTL 2 (Japanese Patent Laid-Open No. 2011-115031) discloses a configuration including a combination of a fuel cell and a battery. In such a configuration, charge and discharge are managed to regulate a depth of discharge of a battery to be shallow such that the battery has a longer life.

This disclosed configuration, however, has the following problems.

(a) Although the use of the fuel cell and the battery makes it possible to supply electric power in parallel, discharge from the battery and recovery (charging) from the fuel cell to the battery require respective separate circuits.

(b) Heat loss of a diode is large.

(c) There is no disclosure on battery replacement.

### CITATION LIST

### Patent Literature

### [PTL 1]

Japanese Patent Laid-Open No. Hei 9-84273

### [PTL 2]

Japanese Patent Laid-Open No. 2011-115031

### SUMMARY

### Technical Problem

An object of the present disclosure is to provide a power source switching apparatus, a robot, a method, and a program that enable switching of a battery (a power source) while allowing electric power to continue to be supplied to a system of a robot or the like, in a manner free from, for example, the above problems of the typical technologies.

### Solution to Problem

According to a first aspect of the present disclosure, there is provided a power source switching apparatus including a first switch circuit provided between a first power source port and a load to be supplied with electric power; a second switch circuit provided between a second power source port and the load; and a controller configured to control the first switch circuit and the second switch circuit. The controller is configured to perform, on each of the first switch circuit and the second switch circuit, a process of switching between three states (a) to (c):

(a) an ON state that indicates a continuity state;

(b) an OFF state that indicates an interruption state; and

(c) a diode operating state where the electric power is allowed to be supplied only in one direction from a power source port side toward a load side in a case where a power-source-port-side voltage is higher than a load-side voltage,

thereby performing a process of switching between power sources individually connected to the first power source port and second power source port without stopping the electric power being supplied to the load.

Further, according to a second aspect of the present disclosure, there is provided a robot including a load including a drive unit, and a power source switching unit configured to perform a control of switching between power sources that supply electric power to the load. The power source switching unit includes a first switch circuit provided between a first power source port and the load to be supplied with the electric power, a second switch circuit provided between a second power source port and the load, and a controller configured to control the first switch circuit and the second switch circuit. The controller is configured to perform, on each of the first switch circuit and the second switch circuit, a process of switching between three states (a) to (c):

(a) an ON state that indicates a continuity state;

(b) an OFF state that indicates an interruption state; and

(c) a diode operating state where the electric power is allowed to be supplied only in one direction from a power source port side toward a load side in a case where a power-source-port-side voltage is higher than a load-side voltage,

thereby performing a process of switching between the power sources individually connected to the first power source port and second power source port without stopping the electric power being supplied to the load.

Further, according to a third aspect of the present disclosure, there is provided a power source switching control method that is performed on a power source switching apparatus. The power source switching apparatus includes a first switch circuit provided between a first power source port and a load to be supplied with electric power; a second switch circuit provided between a second power source port and the load; and a controller configured to control the first switch circuit and the second switch circuit. The controller is configured to perform, on each of the first switch circuit and the second switch circuit, a process of switching between three states (a) to (c):

(a) an ON state that indicates a continuity state;

(b) an OFF state that indicates an interruption state; and

(c) a diode operating state where the electric power is allowed to be supplied only in one direction from a power source port side toward a load side in a case where a power-source-port-side voltage is higher than a load-side voltage,

thereby performing a process of switching between power sources individually connected to the first power source port and second power source port without stopping the electric power being supplied to the load.

Further, according to a fourth aspect of the present disclosure, there is provided a robot control method that is performed on a robot. The robot includes a load including a drive unit, and a power source switching unit configured to perform a control of switching between power sources that supply electric power to the load. The power source switching unit includes a first switch circuit provided between a first power source port and the load to be supplied with the electric power, a second switch circuit provided between a second power source port and the load, and a controller configured to control the first switch circuit and the second switch circuit. The controller is configured to perform, on each of the first switch circuit and the second switch circuit, a process of switching between three states (a) to (c):

(a) an ON state that indicates a continuity state;

(b) an OFF state that indicates an interruption state; and

(c) a diode operating state where the electric power is allowed to be supplied only in one direction from a power source port side toward a load side in a case where a power-source-port-side voltage is higher than a load-side voltage,

thereby performing a process of switching between the power sources individually connected to the first power source port and second power source port without stopping the electric power being supplied to the load.

Further, according to a fifth aspect of the present disclosure, there is provided a program causing a power source switching control process to be performed on a power source switching apparatus. The power source switching apparatus includes a first switch circuit provided between a first power source port and a load to be supplied with electric power; a second switch circuit provided between a second power source port and the load; and a controller configured to control the first switch circuit and the second switch circuit. The program causing the controller to perform, on each of the first switch circuit and the second switch circuit, a process of switching between three states (a) to (c):

(a) an ON state that indicates a continuity state;

(b) an OFF state that indicates an interruption state; and

(c) a diode operating state where the electric power is allowed to be supplied only in one direction from a power source port side toward a load side in a case where a power-source-port-side voltage is higher than a load-side voltage,

thereby performing a process of switching between power sources individually connected to the first power source port and second power source port without stopping the electric power being supplied to the load.

It should be noted that the program of the present disclosure is, for example, a program that can be provided to an information processing apparatus or a computer system capable of execution of a variety of program codes, via a recording medium or a communication medium provided in a computer-readable manner. By providing such a program in a computer-readable manner, a process corresponding to the program is implemented on the information processing apparatus or the computer system.

Other objects, features, advantages of the present disclosure will be found by referring to a further detailed description based on later-described embodiments of the present disclosure and the attached drawings. It should be noted that a system herein refers to a logical cluster configuration including a plurality of apparatuses, and the apparatuses in the configuration are not necessarily disposed within the same casing.

According to the configuration of an embodiment of the present disclosure, an apparatus and a method capable of performing a power source switching process and a charging process without stopping electric power being supplied to a load are implemented.

Specifically, the configuration includes, for example, a first switch circuit provided between a first power source port and a load to be supplied with electric power, a second switch circuit provided between a second power source port and the load, and a controller configured to control each of the switch circuits. The controller is configured to perform, on each of the switch circuits, a process of switching between three states, that is, (a) an ON state, (b) an OFF state, and (c) a diode operating state, thereby performing a process of switching between power sources connected to the respective power source ports without stopping the electric power being supplied to the load. Further, the controller is configured to perform a battery charging with a regenerative energy resulting from a rotation of a motor, which is the load.

According to the present configuration, an apparatus and a method capable of performing a power source switching process and a charging process without stopping electric power being supplied to a load are implemented.

It should be noted that the effects described herein are merely by way of example without limitation, and an additional effect may be provided.

### BRIEF DESCRIPTION OF DRAWINGS

FIG. 1 is a diagram for explaining a specific example and a problem of a power source replacement work for a battery-powered robot.

FIG. 2 is a diagram for explaining an example of a robot where a battery is replaced while electric power continues to be supplied from the battery.

FIG. 3 illustrates diagrams for explaining an example of a battery replacement process using a diode OR circuit.

FIG. 4 is a diagram for explaining an example where a regenerative current generated by the rotation of a motor is interrupted by a diode.

FIG. 5 illustrates diagrams for explaining an example of an ideal diode circuit.

FIG. 6 is a diagram for explaining an example where a regenerative current generated by the rotation of a motor is interrupted by the ideal diode circuit.

FIG. 7 illustrates diagrams for explaining respective states of the ideal diode circuit during (a) a live-line plugging/unplugging (hot swap) process for a battery and (b) recovery of a regenerative energy.

FIG. 8 is a diagram for explaining a configuration example of a power source switching apparatus of the present disclosure.

FIG. 9 is a flowchart for explaining a sequence of a process to be performed by the power source switching apparatus of the present disclosure.

FIG. 10 is a flowchart for explaining a sequence of a process to be performed by the power source switching apparatus of the present disclosure.

FIG. 11 is a diagram for explaining a configuration example of the power source switching apparatus of the present disclosure.

FIG. 12 is a diagram for explaining a configuration example of the power source switching apparatus of the present disclosure.

FIG. 13 is a diagram for explaining a configuration example of the power source switching apparatus of the present disclosure.

FIG. 14 is a diagram for explaining a configuration example of the power source switching apparatus of the present disclosure.

FIG. 15 is a diagram for explaining a hardware configuration example of a traveling robot of the present disclosure.

### DESCRIPTION OF EMBODIMENTS

A detailed description will be made below regarding a power source switching apparatus, a robot, a method, and a program of the present disclosure with reference to the drawings. It should be noted that the description will be given in an order of the following items.

1. Specific examples and problems of a power source replacement work for a robot

2. Power source switching configuration of the present disclosure, power source switching process, and energy regeneration process

3. Sequence of a process to be performed by the power source switching apparatus of the present disclosure

4. Process sequence for a case where an initial state is different

5. Other embodiments

6. Hardware configuration example of a robot

7. Summary of configurations of the present disclosure

### 1. Specific Examples and Problems of a Power Source Replacement Work for a Robot

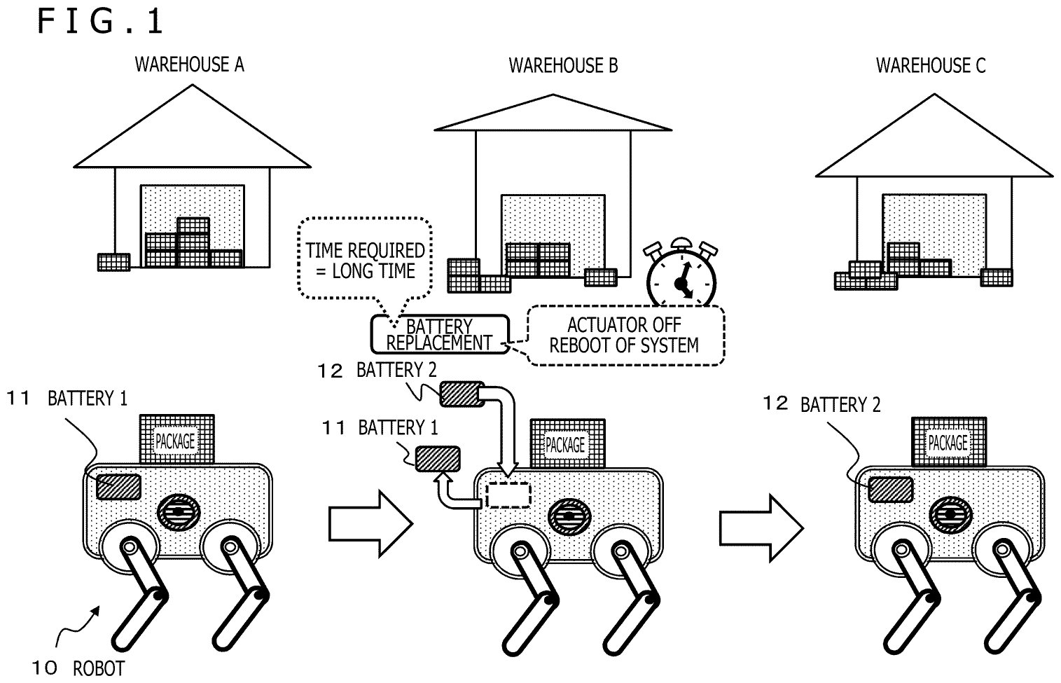

First, a description will be made regarding specific examples and problems of a power source replacement work for a battery-powered robot with reference to FIG. 1 and subsequent ones.

FIG. 1 illustrates a robot 10 that is powered by a battery (a power source).

The robot 10 is a walking robot and moves between a warehouse A, a warehouse B, and a warehouse C, performing a process of transporting packages in the warehouses.

The robot 10 is equipped with a removable battery. For example, the robot 10 is attached with a battery 1, 11 at a start point, i.e., the warehouse A, and moves to the warehouse B. Here, for the reason of a fall in a battery level of the battery 1, 11, the battery 1, 11 is removed from the robot 10, and a new battery 2, 12 is attached to the robot 10.

For this battery replacement process, it has been typically necessary to remove the battery 1, 11 from the robot 10 after electric power supplied to an actuator of the robot 10 is turned off, then attach the battery 2, 12 to the robot, and, at the end, perform a system reboot process, that is, a reboot process to start supplying electric power again to the actuator of the robot 10 from the new battery 2, 12.

Thus, the battery replacement work disrupts a task due to a loss of an actuator power source and requires reboot of the system, and becomes a major cause of a decrease in operation efficiency of the robot.

As measures to avoid such a decrease in operation efficiency due to the battery replacement work, it is effective to replace a battery while electric power continues to be supplied to the system from the battery.

By replacement of a battery with power supply maintained, which is what is called live-line plugging/unplugging, active plugging/unplugging, or hot swap, the battery can be replaced without the necessity of performing a power-off process on a system load such as an actuator, the system reboot process, and the like. Therefore, it is possible to avoid a decrease in operation efficiency due to the battery replacement work.

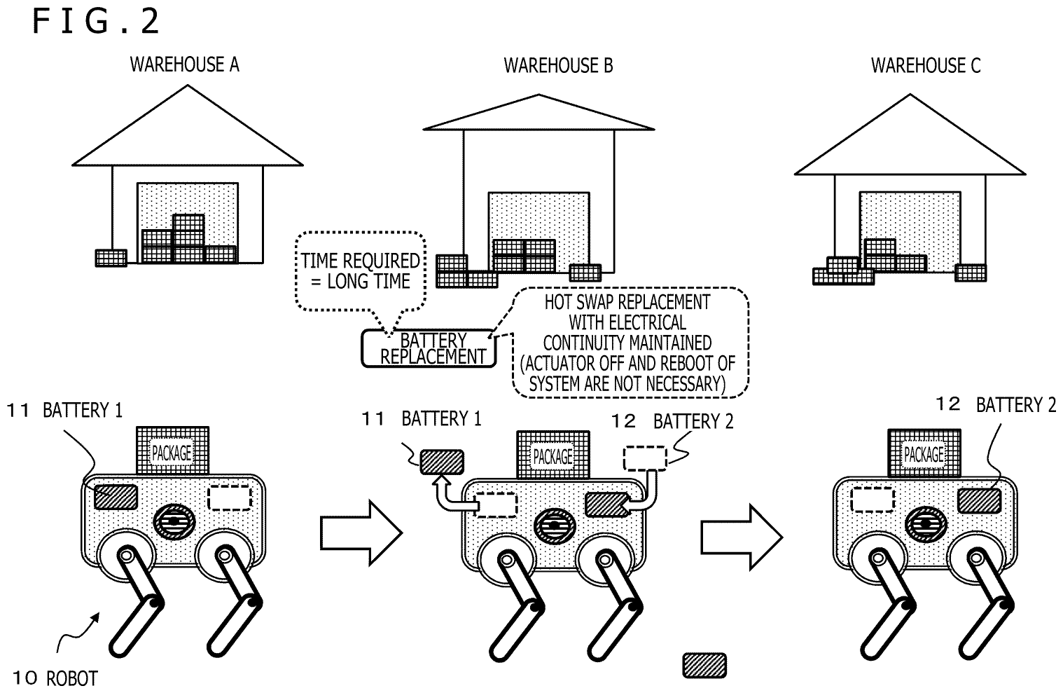

FIG. 2 is a diagram illustrating a specific example where a battery is replaced while electric power continues to be supplied from the battery.

Similarly to the case in FIG. 1, battery replacement is performed at a point of the warehouse B. However, for the robot 10 illustrated in FIG. 2, the new battery 2, 12 is attached to the robot 12 while electric power is being supplied from the battery 1, 11, and the power supplied from the battery 1, 11 to the robot 10 is switched to power supplied from the new battery 2, 12 to the robot 10 after completion of the attachment. The battery 1, 11 is then removed from the robot 10.

Such battery replacement performed while electric power continues to be supplied to the system from the battery eliminates the necessity of performing the power-off process on a system load such as the actuator of the robot 10, the system reboot process, and the like. Therefore, it is possible to reduce time required for battery replacement and achieve an efficient robot operation.

A diode OR circuit is known as a circuit configuration enabling such battery replacement with power supply maintained.

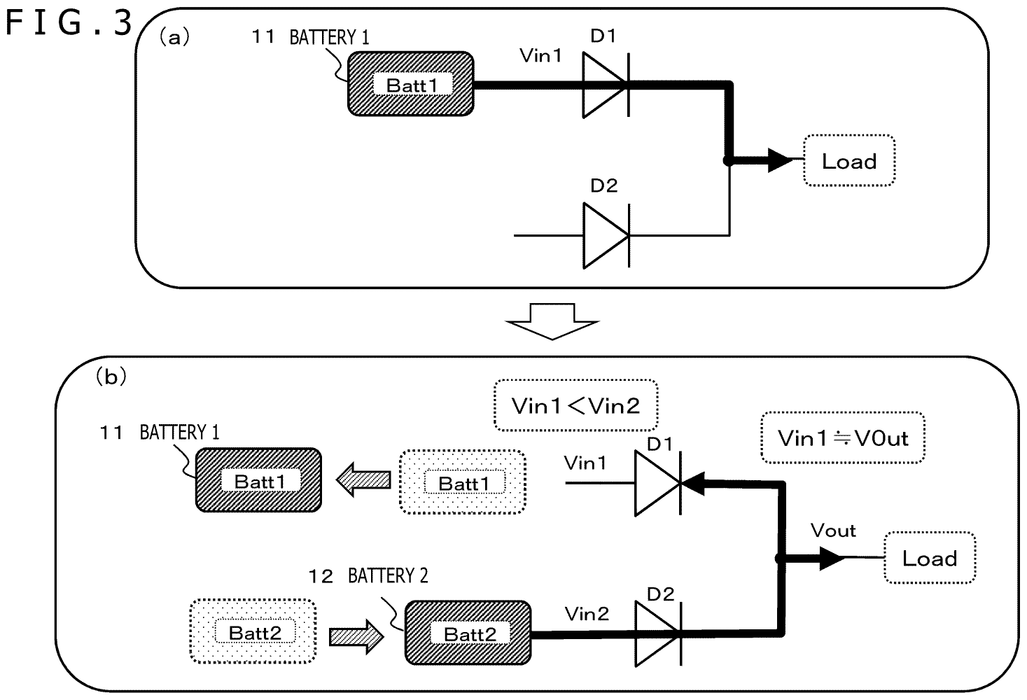

A description will be made regarding a battery replacement process using the diode OR circuit with reference to FIG. 3.

FIG. 3(a) illustrates a configuration where the battery 1, 11 is connected to a diode D1 that is one of diodes in the diode OR circuit.

In this configuration, electric power is supplied to a system load from the battery 1, 11.

FIG. 3(b) illustrates a battery replacement work.

With the battery 1, 11 connected to the diode D1 that is the one of the diodes in the diode OR circuit, the battery 2, 12 is connected to a diode D2 that is the other diode in the diode OR circuit.

The battery 1, 11 has been used for a certain period of time, and a voltage thereof is thus lowered. In contrast, the battery 2, 12 has not been used yet, and a voltage thereof is not lowered. In other words, a relation

Vin1<Vin2

is true, where Vin1 is the voltage of the battery 1, 11 and Vin2 is the voltage of the battery 2, 12.

When the two batteries having such a difference in voltage are simultaneously connected to the diode OR circuit, a current flows as indicated by arrows on the circuit illustrated in FIG. 3(b).

In other words, electric power is supplied from the battery 2, 12 with a higher voltage through the diode D2 to the system load. A current from the battery 2, 12 with a higher voltage reaches the diode D1 through the diode D2 but does not flow further into the diode D1 by virtue of rectification of the diode D1. The battery 1, 11 is removed in this state.

The use of the diode OR circuit thus makes it possible to replace the battery with power supply maintained.

However, this configuration is disadvantageous in that the battery cannot be charged by recovery of a regenerative energy.

For example, a motor is often used as a system load in a robot or the like. When the motor is caused to rotate by an external force, the motor behaves as a power generator, generating electric power. The generated electric power is supplied to a battery, thereby making it possible to charge the battery.

Such an energy generated by the load is referred to as regenerative energy, and energy saving can be achieved by efficiently using the regenerative energy. An emphasis has recently been placed on such an efficient use of a regenerative energy.

In a case where a motor is connected as a system load, the motor is caused to rotate by an external force, thereby generating a power-generation current (a regenerative current) from the motor toward a power source. However, in the configuration illustrated in FIG. 3, the regenerative current generated by the rotation of the motor is interrupted by the diode and is not supplied to the battery.

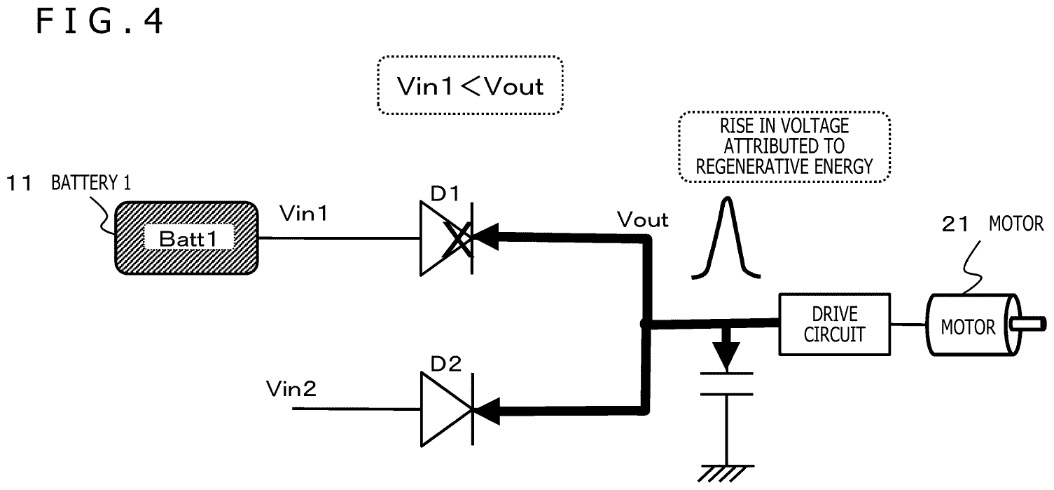

FIG. 4 illustrates a specific example. As illustrated in FIG. 4, when a load-side motor 21 rotates and predetermined conditions are satisfied, a load-side voltage Vout becomes higher than the voltage Vin1 of the battery 1, 11 connected to the diode D1. In other words, settings are made that satisfies the following expression.

Vin1<Vout

If no diode D1 is provided, a current (a regenerative current) generated by the rotation of the load-side motor 21 is supplied to the battery 1, 11, enabling charge of the battery 1, 11, that is, recovery of the regenerative energy.

However, in the configuration illustrated in FIG. 4, a regenerative current generated by the rotation of the motor is interrupted by the diode D1 due to the rectification of the diode D1 and is not supplied to the battery 1, 11. In other words, the battery 1, 11 cannot be charged with the regenerative current. Further, the regenerative current which is not used to charge the battery and has nowhere to go causes a rapid increase in voltage in a power source line, possibly resulting in damaging of a peripheral device.

Thus, in the diode OR circuit, the regenerative current from the motor is also rectified by the diode, so that the regenerative energy cannot be recovered to the battery.

It should be noted that, in a configuration using a diode OR circuit, a loss attributed to a forward voltage drop of the diode is often a problem for an intended use with a high current. To solve this problem, in place of a diode itself, a circuit where a transistor is used to emulate rectification properties of a diode, i.e., an ideal diode circuit, is often used.

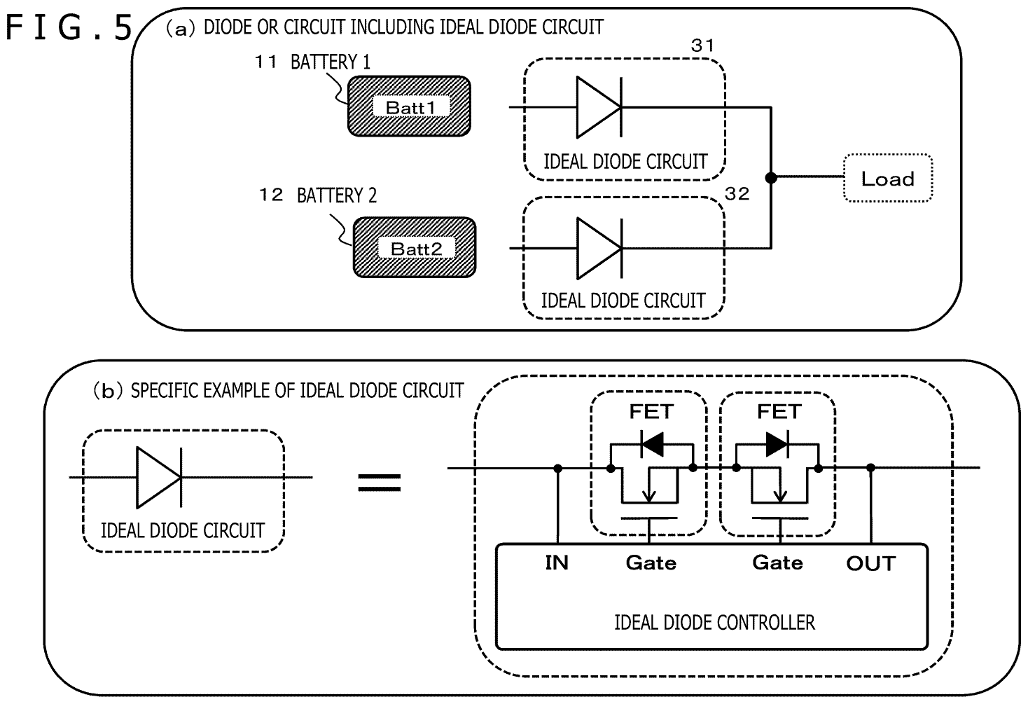

An example of an ideal diode circuit will be described with reference to FIG. 5.

FIG. 5(a) illustrates a configuration example of a diode OR circuit including ideal diode circuits 31 and 32.

FIG. 5(b) is a diagram illustrating an example of a detailed circuit configuration of the ideal diode circuit.

As illustrated in FIG. 5(b), the ideal diode circuit may include a plurality of FETs controllable by an ideal diode controller.

With the use of the ideal diode circuit as illustrated in FIG. 5(b), a loss attributed to a forward voltage drop of a diode can be reduced.

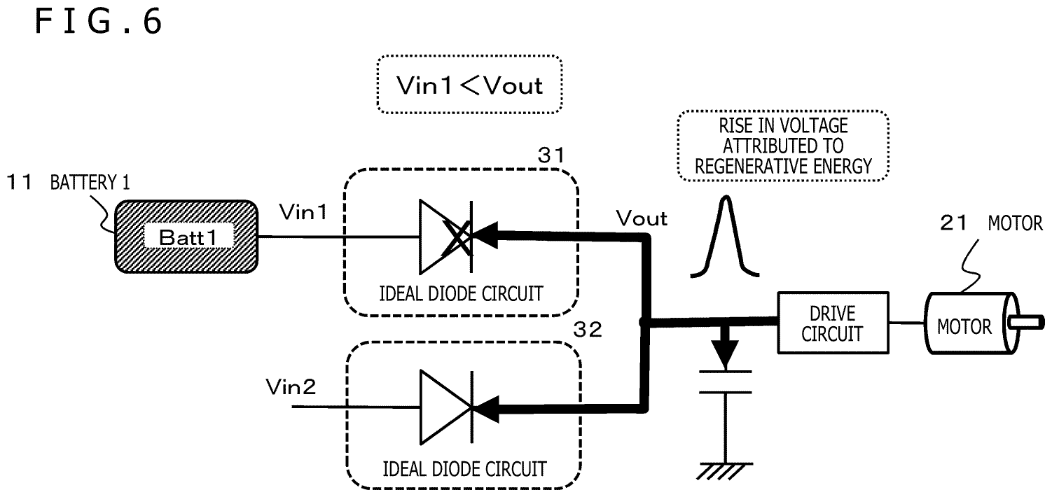

However, even in a case where the diode OR circuit including such an ideal diode circuit is used, a regenerative current generated by the rotation of the motor 21 is interrupted by the diode ideal circuit 31 and is not supplied to the battery 1, 11 as illustrated in FIG. 6. In other words, the battery 1, 11 cannot be charged with the regenerative current. Further, the regenerative current which is not used to charge the battery and has nowhere to go causes a rapid increase in voltage in a power source line, possibly resulting in damaging of a peripheral device.

One of reasons why a regenerative energy cannot be recovered in a case where a diode OR circuit is used is that, in the diode OR circuit, the diode cannot distinguish between a rise in output-side voltage attributed to a live-line plugging/unplugging operation (hot swap) and a rise in output-side voltage attributed to a regenerative energy.

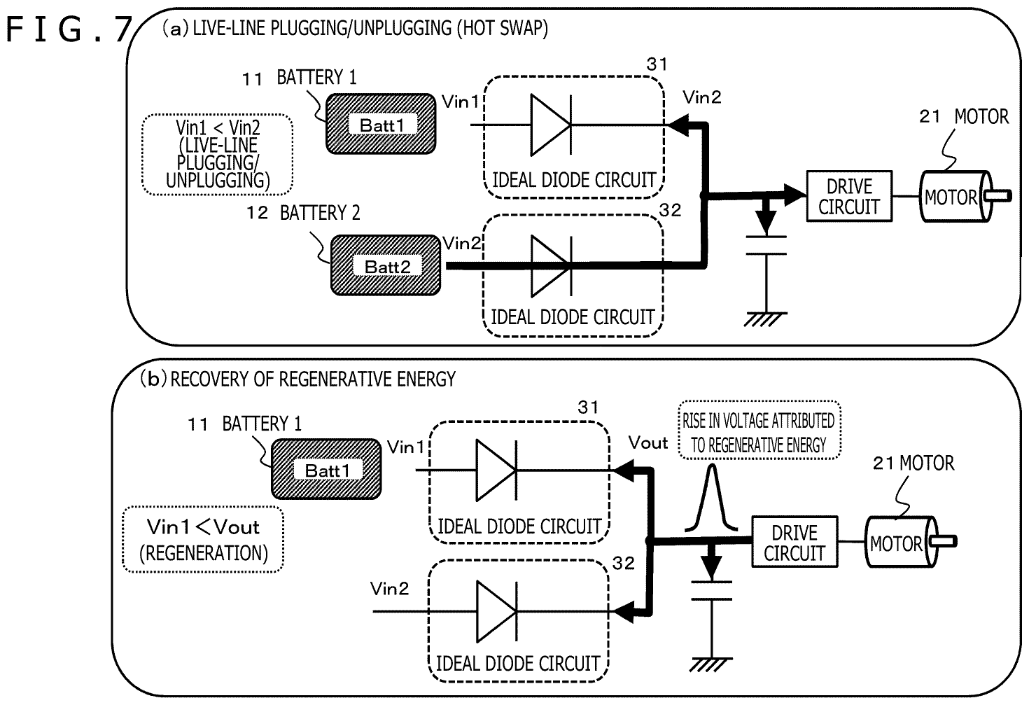

A description will be made regarding this problem with reference to FIG. 7.

FIG. 7 illustrates diagrams for explaining respective states of the ideal diode circuit during two different processes.

(a) During a live-line plugging/unplugging (hot swap) process for a battery

(b) During recovery of a regenerative energy

In the state seen during the live-line plugging/unplugging (hot swap) process for a battery in FIG. 7(a), a relation between voltages at right and left end portions of the ideal diode circuit 31 that is one of the ideal diode circuits in the diode OR circuit, i.e., a relation between the voltage (Vin1) on a battery 1, 11 side and the voltage (Vin2) on a load (motor 21) side, is set to the following relation.

Vin1<Vin2

In contrast, in the state seen during recovery of a regenerative energy in FIG. 7(b), the relation between the voltages at the right and left end portions of the ideal diode circuit 31, i.e., the relation between the voltage (Vin1) on the battery 1, 11 side and the voltage (Vout) on the load (motor 21) side, is set to the following relation.

Vin1<Vout

For the ideal diode circuit 31, the two states illustrated in FIGS. 7(a) and 7(b) both indicate that the voltage on the battery 1, 11 side is lower than the voltage on an external load side. Thus, from the point of view of the ideal diode circuit 31, these two states are indistinguishable.

Accordingly, the reason why a regenerative energy cannot be recovered in the configuration using a diode OR circuit is that a rise in output-side voltage attributed to the live-line plugging/unplugging operation (hot swap) and a rise in output-side voltage attributed to a regenerative energy are indistinguishable.

### 2. Power Source Switching Configuration of the Present Disclosure, Power Source Switching Process, and Energy Regeneration Process

Next, a description will be made regarding a power source switching configuration of the present disclosure, a power source switching process, and an energy regeneration process.

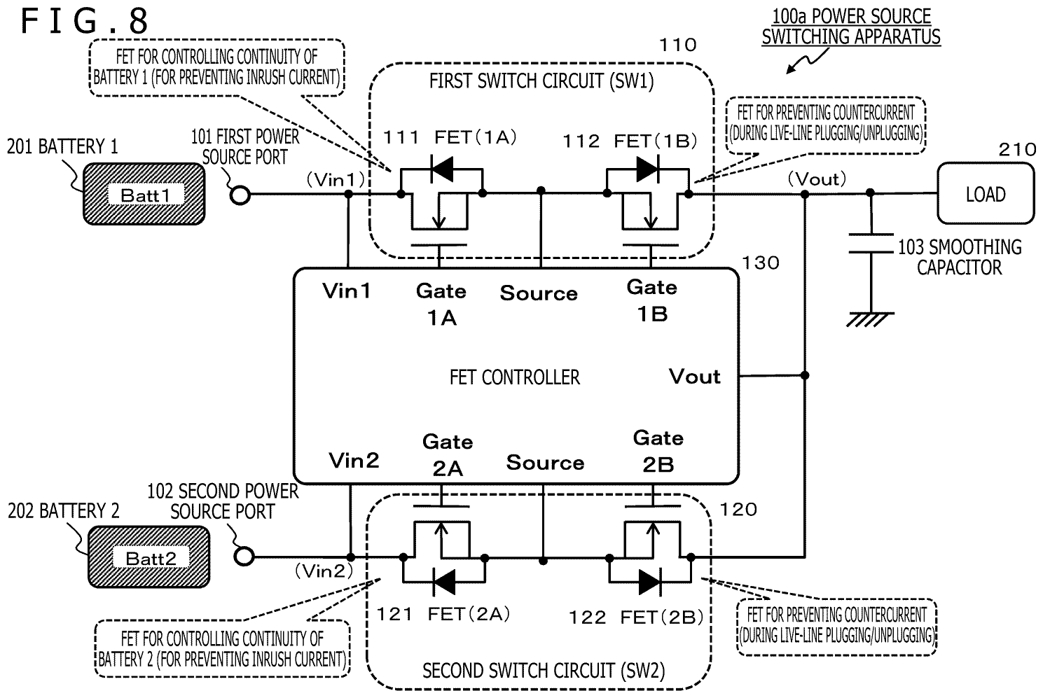

FIG. 8 illustrates a configuration example of the power source switching apparatus of the present disclosure.

A power source switching apparatus 100a illustrated in FIG. 8 is provided, for example, within the robot 10 described with reference to FIG. 1 and FIG. 2.

A load 210 illustrated in FIG. 8 includes, for example, a CPU that controls the robot, an actuator that performs driving, a motor, and the like. In a case where the load includes the motor, a regenerative energy (a regenerative current) is generated by the rotation of the motor.

It should be noted that a smoothing capacitor 103 placed upstream of the load 210 is a capacitive load present in an output line and is a capacitor for reducing and stabilizing (smoothing) a variation in output to the load 210.

As illustrated in FIG. 8, the power source switching apparatus 100a includes two power source ports, that is, a first power source port 101 and a second power source port 102.

The first power source port 101 is connected to a battery 1, 201, and the second power source port 102 is connected to a battery 2, 202.

It should be noted that one of the battery 1, 201 and the battery 2, 202 is normally connected to the port, and electric power is supplied to the load 210 from the connected battery. However, during such battery replacement that a battery is replaced with power supply maintained, which is referred to as live-line plugging/unplugging, active plugging/unplugging, or hot swap, the two batteries are temporarily connected to the respective ports.

When the battery replacement work is completed, the old battery is removed.

The first power source port 101 of the power source switching apparatus 100a is connected to the load 210 through a first switch circuit (SW1) 110.

Similarly, the second power source port 102 is connected to the load 210 through a second switch circuit (SW2) 120.

The first switch circuit (SW1) 110 connected to the first power source port 101 includes two FETs, i.e., an FET (1A) 111 and an FET (1B) 112.

The FET (1A) 111 is an FET for controlling electrical continuity of the battery 1, 201 and controls electric power supplied to the outside from the battery 1, 201 through the first switch circuit 110.

Specifically, an FET controller 130 controls a gate-source voltage of the FET (1A) 111, thereby controlling continuity and interruption for a current in a direction from input (a battery side) to output (a load side).

Further, a gate voltage of the FET (1A) 111 is controlled by the FET controller 130, which makes it possible to control a continuity/interruption speed of the FET (1A) 111. This makes it possible to reduce an inrush current to the output-side capacitive load (the smoothing capacitor 103).

The load-side FET (1B) 112 of the first switch circuit (SW1) 110 is an FET for preventing a countercurrent. Specifically, the FET controller 130 controls a gate-source voltage of the FET (1B) 112, thereby controlling continuity and interruption for a current in a direction from output (the load side) to input (the battery side).

Controlling the two FETs of the first switch circuit (SW1) 110, i.e., the FET (1A) 111 and the FET (1B) 112, enables the first switch circuit (SW1) 110 to be set in the following three states.

(a) an ON state

(b) an OFF state

(c) an ideal diode operating state

It should be noted that setting and transition between these three states are controllable by the FET controller 130.

(a) The ON state is a state where the first switch circuit (SW1) 110 is brought into electrical continuity.

It is a state where a current in the direction from input (the battery side) to output (the load side) through the first switch circuit (SW1) 110 and a current in the direction from output (the load side) to input (the battery side) through the first switch circuit (SW1) 110 are both carried.

(b) The OFF state is a state where the first switch circuit (SW1) 110 is interrupted.

It is a state where a current in the direction from input (the battery side) to output (the load side) through the first switch circuit (SW1) 110 and a current in the direction from output (the load side) to input (the battery side) through the first switch circuit (SW1) 110 are both interrupted.

(c) The ideal diode operating state is an operating state depending on diode properties, more specifically, in a case where an input-side (battery-side) voltage of the first switch circuit (SW1) 110 is larger than an output-side (load-side) voltage, the current in the direction from input (the battery side) to output (the load side) through the first switch circuit (SW1) 110 is carried, and

in a case where the output-side (load-side) voltage exceeds the input-side (battery-side) voltage of the first switch circuit (SW1) 110, the current in the direction from output (the load side) to input (the battery side) is interrupted.

It should be noted that, in (a) the ON state, the first switch circuit (SW1) 110 is always in a continuity state without dependence on the input-side (battery-side) and output-side (load-side) voltages of the first switch circuit (SW1) 110.

In contrast, in (b) the OFF state, the first switch circuit (SW1) 110 is always in an interruption state without dependence on the input-side (battery-side) and output-side (load-side) voltages of the first switch circuit (SW1) 110.

Similarly, the second switch circuit (SW2) 120 connected to the second power source port 102 includes two FETs, i.e., an FET (2A) 121 and an FET (2B) 122.

The FET (2A) 121 is an FET for controlling electrical continuity of the battery 2, 202 and controls electric power supplied to the outside from the battery 2, 202 through the second switch circuit 120. Specifically, the FET controller 130 controls a gate-source voltage of the FET (2A) 121, thereby controlling continuity and interruption for a current in a direction from input (a battery side) to output (a load side).

Further, a gate voltage of the FET (2A) 121 is controlled by the FET controller 130, which makes it possible to control a continuity/interruption speed of the FET (2A) 121. This makes it possible to reduce an inrush current to the output-side capacitive load (the smoothing capacitor 103).

The load-side FET (2B) 122 of the second switch circuit (SW2) 120 is an FET for preventing a countercurrent. Specifically, the FET controller 130 controls a gate-source voltage of the FET (2B) 122, thereby controlling continuity and interruption for a current in a direction from output (the load side) to input (the battery side).

Controlling the two FETs of the second switch circuit (SW2) 120, i.e., the FET (2A) 121 and the FET (2B) 122, enables the second switch circuit (SW2) 120 to be set in the following three states.

(a) the ON state

(b) the OFF state

(c) the ideal diode operating state

It should be noted that setting and transition between these three states are controllable by the FET controller 130.

(a) The ON state is a state where the second switch circuit (SW2) 120 is brought into electrical continuity.

It is a state where a current in the direction from input (the battery side) to output (the load side) through the second switch circuit (SW2) 120 and a current in the direction from output (the load side) to input (the battery side) through the second switch circuit (SW2) 120 are both carried.

(b) The OFF state is a state where the second switch circuit (SW2) 120 is interrupted.

It is a state where a current in the direction from input (the battery side) to output (the load side) through the second switch circuit (SW2) 120 and a current in the direction from output (the load side) to input (the battery side) through the second switch circuit (SW2) 120 are both interrupted.

(c) The ideal diode operating state is an operating state depending on diode properties, more specifically,

in a case where an input-side (battery-side) voltage of the second switch circuit (SW2) 120 is larger than an output-side (load-side) voltage, the current in the direction from input (the battery side) to output (the load side) through the second switch circuit (SW2) 120 is carried, and

in a case where the output-side (load-side) voltage exceeds the input-side (battery-side) voltage of the second switch circuit (SW2) 120, the current in the direction from output (the load side) to input (the battery side) is interrupted.

It should be noted that, in (a) the ON state, the second switch circuit (SW2) 120 is always in a continuity state without dependence on the input-side (battery-side) and output-side (load-side) voltages of the second switch circuit (SW2) 120.

In contrast, in (b) the OFF state, the second switch circuit (SW2) 120 is always in an interruption state without dependence on the input-side (battery-side) and output-side (load-side) voltages of the second switch circuit (SW2) 120.

The FET controller 130 controls the gate-source voltages of the four FETs: the two FETs of the first switch circuit (SW1) 110, i.e., the FET (1A) 111 and the FET (1B) 112, and the two FETs of the second switch circuit (SW2) 120, i.e., the FET (2A) 121 and the FET (2B) 122.

The FET controller 130 includes the following three voltage detection units.
(1) Vin1: the input-side voltage of the first switch circuit (SW1) 110 (=the output voltage of the battery 1, 201)
(2) Vin2: the input-side voltage of the second switch circuit (SW2) 120 (=the output voltage of the battery 2, 202)
(3) Vout: the output-side voltage of each of the switch circuits 110 and 120

The FET controller 130 compares these three voltages, i.e., Vin1, Vin2, and Vout, and controls the gate voltages of the four FETs of the first switch circuit (SW1) 110 and the second switch circuit (SW2) 120 on the basis of a comparison result.

Specifically, the three states (the ON state, the OFF state, and the ideal diode operating state) of each of the switch circuits 110 and 120 are switched on the basis of the comparison result of Vin1, Vin2, and Vout. Through this switching, a switching control for the following three types of processes is performed.

(Process 1) normal process: a process of supplying electric power from the battery to the load

(Process 2) live-line plugging/unplugging process (hot swap): a battery switching process performed while electric power continues to be supplied to the load

(Process 3) regeneration process: a process of charging the battery by supplying the battery with a regenerative energy (a regenerative current) resulting from the rotation of the motor of the load

### 3. Sequence of a Process to be Performed by the Power Source Switching Apparatus of the Present Disclosure

Next, a description will be made regarding a sequence of a process to be performed by the power source switching apparatus of the present disclosure. Specifically, a description will be made regarding a sequence of a process to be performed by the FET controller 130.

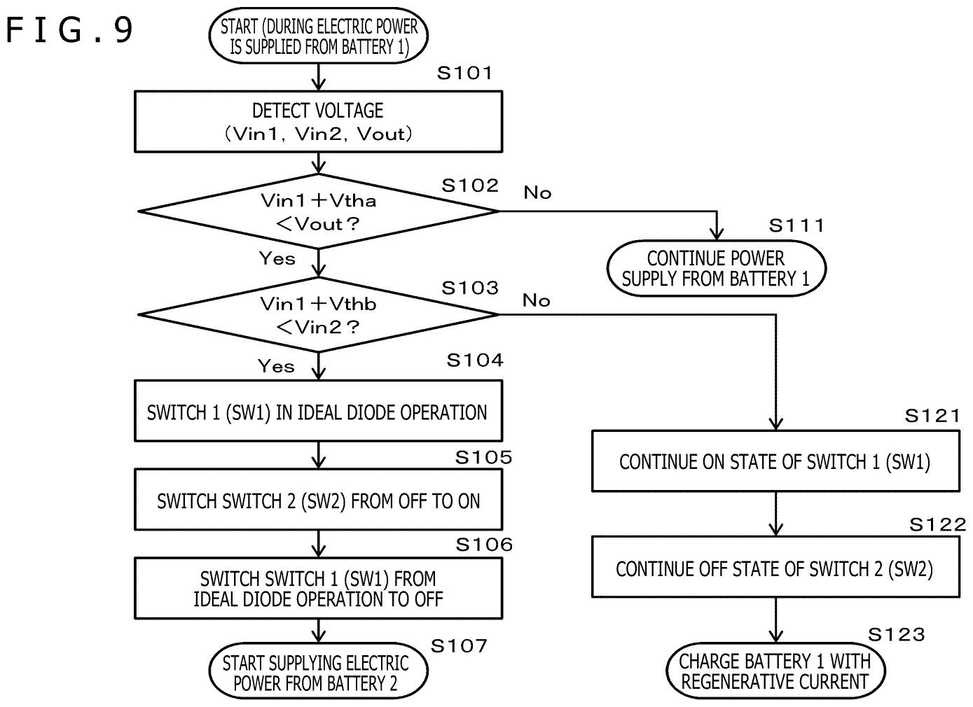

FIG. 9 is a flowchart for explaining the sequence of the process to be performed by the FET controller 130. The FET controller 130 performs the process according to, for example, a program stored in a memory inside the FET controller 130 or in an external memory. The FET controller 130 holds a processor having a program execution function and performs the process based on a flow described below according to control performed by the processor.

It should be noted that, in the flow illustrated in FIG. 9, an initial state (a start state) is a normal process state where electric power is supplied from the battery 1, 201 to the load 210 through the first switch circuit (SW1) 110 in the configuration illustrated in FIG. 8.

In other words, in the initial state, as a result of a gate voltage control performed on the FETs of each of the switches by the FET controller 130, the following state is set.

first switch circuit (SW1) 110=ON

second switch circuit (SW2) 120=OFF A description will be made below regarding a process in each step of the flow illustrated in FIG. 9.

(Step S101)

First, in Step S101, the FET controller 130 detects the following three voltages.

(1) Vin1: the input-side voltage of the first switch circuit (SW1) 110 (=the output voltage of the battery 1, 201)

(2) Vin2: the input-side voltage of the second switch circuit (SW2) 120 (=the output voltage of the battery 2, 202)

(3) Vout: the output-side voltage of each of the switch circuits 110 and 120

(Step S102)

Next, in Step S102, the FET controller 130 performs a process of comparing Vin1 and Vout, determining whether or not the expression

Vin1+Vtha<Vout

is true, where

Vin1 is the input-side voltage of the first switch circuit (SW1) 110 (=the output voltage of the battery 1, 201),

Vout is the output-side voltage of each of the switch circuits 110 and 120, and

Vtha is a predetermined threshold value.

The threshold value Vtha can be set as desired by a user.

The threshold value Vtha can be set to any value equal to or more than 0. However, for example, in a case where the threshold value Vtha=0 and where Vin1 and Vout are substantially the same in value, the operation is likely to be frequently switched and become unstable.

For a stable operation, it is favorable that a value slightly larger than 0 be set.

The process proceeds to Step S103 in a case where it is determined in Step S102 that the following expression is true.

Vin1+Vtha<Vout

In contrast, in a case where it is determined that the above expression is not true, the process proceeds to Step S111.

(Step S111)

First, a description will be made regarding a process in Step S111 for the case where the expression

Vin1+Vtha<Vout

is determined to be not true in Step S102.

Vin1+Vtha<Vout

In the case where the above expression is not true, the following relation is satisfied.

Vin1+Vtha≥Vout

In other words,

a value given by adding the threshold value Vtha to Vin1: the input-side voltage of the first switch circuit (SW1) 110 (=the output voltage of the battery 1, 201) is equal to or more than

Vout: the output-side voltage of each of the switch circuits 110 and 120.

In this case, in Step S111, a present operating state, that is, the normal process state where electric power is supplied from the battery 1, 201 to the load 210 through the first switch circuit (SW1) 110, is continued.

The process of supplying electric power from the battery 1, 201 to the load 210 is a process performed when the FET controller 130 sets (maintains) the respective switch circuits in the following operating states.

first switch circuit (SW1) 110=ON

second switch circuit (SW2) 120=OFF

As a result of the above settings, the electric power continues to be supplied from the battery 1, 201 to the load 210 through the first switch circuit (SW1) 110 which is set in the ON state.

(Step S103)

In contrast, in the case where it is determined in Step S102 that the expression

Vin1+Vtha<Vout

is true, the process proceeds to Step S103.

In Step S103, the FET controller 130 performs a process of comparing Vin1 and Vin2, determining whether or not the expression

Vin1+Vthb<Vin2

is true, where

Vin1 is the input-side voltage of the first switch circuit (SW1) 110 (=the output voltage of the battery 1, 201),

Vin2 is the input-side voltage of the second switch circuit (SW2) 120 (=the output voltage of the battery 2, 202), and

Vthb is a predetermined threshold value.

The threshold value Vthb can be set as desired by a user.

Similarly to Vtha described above, the threshold value Vthb can be set to any value equal to or more than 0. However, for example, in a case where the threshold value Vthb=0, the operation is likely to be frequently switched and become unstable. For a stable operation, it is favorable that a value slightly larger than 0 be set.

The process proceeds to Step S104 in a case where it is determined in Step S103 that the following expression is true.

Vin1+Vthb<Vin2

In contrast, in a case where it is determined that the above expression is not true, the process proceeds to Step S121.

It should be noted that, in the case where the expression

Vin1+Vthb<Vin2

is true in Step S103, the battery 2, 202, which is higher in voltage than the battery 1, 201, is connected to the input-side second power source port 102 of the second switch circuit (SW2) 120. In other words, an unused battery for replacement is connected to the input-side second power source port 102.

Thus, the determination process in Step S103 corresponds to a process of determining whether or not the unused battery 2, 202 for replacement is connected to the input-side second power source port 102 of the second switch circuit (SW2) 120.

In the case where the expression

Vin1+Vthb<Vin2

is true in Step S103, the unused battery 2, 202 for replacement is determined to be connected to the input-side second power source port 102 of the second switch circuit (SW2) 120, and, in Step S104 and subsequent steps, a live-line plugging/unplugging (hot swapping) process for a battery is performed.

In contrast, in the case where the above expression is determined to be not true, the unused battery 2, 202 for replacement is determined to be not connected to the input-side second power source port 102 of the second switch circuit (SW2) 120, and, in Step S121 and subsequent steps, a charging process for the battery 1, 201, that is, a process of charging the battery 1, 201 with a regenerative energy (a regenerative current) generated by the motor of the load 210, is performed.

(Step S104)

The process in Steps S104 to S107 corresponds to the live-line plugging/unplugging (hot swapping) process for a battery.

The live-line plugging/unplugging (hot swapping) process for a battery in Steps S104 to S107 is performed in a case where it is determined in Step S102 and Step S103 that the following two expressions are true.

Vin1+Vtha<Vout

Vin1+Vthb<Vin2

In other words, the live-line plugging/unplugging (hot swapping) process for a battery is performed in a case where the following conditions are satisfied:

a value given by adding the threshold value Vtha to Vin1: the input-side voltage of the first switch circuit (SW1) 110 (=the output voltage of the battery 1, 201) is less than

Vout: the output-side voltage of each of the switch circuits 110 and 120; and

a value given by adding the threshold value Vthb to Vin1: the input-side voltage of the first switch circuit (SW1) 110 (=the output voltage of the battery 1, 201) is less than

Vin2: the input-side voltage of the second switch circuit (SW2) 120 (=the output voltage of the battery 2, 202).

In the case where these conditions are satisfied, the FET controller 130 determines that the new unused battery 2, 202 for replacement is connected to the input-side second power source port 102 of the second switch circuit (SW2) 120, and, in Step S104 and subsequent steps, performs the live-line plugging/unplugging (hot swapping) process for a battery.

First, in Step S104, the FET controller 130 changes the first switch circuit (SW1) 110 from the ON state to the ideal diode operating state.

This state change process is performed as a result of the gate voltage control performed by the FET controller 130 on the two FETs of the first switch circuit (SW1) 110, that is, the FET (1A) 111 and the FET (1B) 112, so as to switch the continuity/interruption state of each of the FETs.

As described above, the ideal diode operating state is an operating state depending on diode properties. Specifically, in a case where the input-side (battery-side) voltage of the first switch circuit (SW1) 110 is larger than the output-side (load-side) voltage, the current in the direction from input (the battery side) to output (the load side) through the first switch circuit (SW1) 110 is carried, and

in a case where the output-side (load-side) voltage exceeds the input-side (battery-side) voltage of the first switch circuit (SW1) 110, the current in the direction from output (the load side) to input (the battery side) is interrupted.

(Step S105)

Next, in Step S105, the FET controller 130 changes the second switch circuit (SW2) 120 from the OFF state to the ON state.

This state change process is likewise performed as a result of the gate voltage control performed by the FET controller 130 on the two FETs of the second switch circuit (SW2) 120, that is, the FET (2A) 121 and the FET (2B) 122, so as to switch the continuity/interruption state of each of the FETs.

(Step S106)

Next, in Step S106, the FET controller 130 changes the first switch circuit (SW1) 110 from the ideal diode operating state to the OFF state.

This state change process is likewise performed as a result of the gate voltage control performed by the FET controller 130 on the two FETs of the first switch circuit (SW1) 110, that is, the FET (1A) 111 and the FET (1B) 112, so as to switch the continuity/interruption state of each of the FETs.

(Step S107)

In Step S107, as a result of the above-described process in Steps S104 to S106, electric power starts being supplied from the battery 2, 202 to the load 210 through the second switch circuit (SW2) 120.

In other words,

a process of a change from

a start state=a state where electric power is supplied from the battery 1, 201 to the load 210 through the first switch circuit (SW1) 110, to

Step S107=a state where electric power is supplied from the battery 2, 202 to the load 210 through the second switch circuit (SW2) 120

is performed without stopping the electric power being supplied to the load 210.

That is, the live-line plugging/unplugging (hot swapping) process for a battery is completed.

This live-line plugging/unplugging (hot swapping) process for a battery is a process performed when the FET controller 130 sets the respective switch circuits in the following operating states in sequence.

(S104) first switch circuit (SW1) 110=from the ON state to the ideal diode operating state

(S105) second switch circuit (SW2) 120=from the OFF state to the ON state

(S106) first switch circuit (SW1) 110=from the ideal diode operating state to the OFF state

By performing the above operating state change processes for the switch circuits in sequence, it is possible to perform the live-line plugging/unplugging (hot swapping) process for a battery without stopping electric power being supplied to the load 210.

In other words, first, (S104) the first switch circuit (SW1) 110=from the ON state to the ideal diode operating state is achieved, and thus, electric power continues to be supplied from the battery 1, 201 to the load 210 through the first switch circuit (SW1) 110.

As described above, the ideal diode operating state is an operating state where, in a case where the input-side (battery-side) voltage of the first switch circuit (SW1) 110 is larger than the output-side (load-side) voltage, a current in the direction from input (battery side) to output (load side) through the first switch circuit (SW1) 110 is carried.

Next, (S105) the second switch circuit (SW2) 120=from the OFF state to the ON state is achieved, and thus, electric power starts being supplied from the battery 2, 202, which is connected to the input side (battery side) of the second switch circuit (SW2) 120, to the load 210 through the second switch circuit (SW2) 120.

It should be noted that, although the output-side (load-side) voltage is likely to exceed the input side (battery side) of the first switch circuit (SW1) 110 at this point of time, a current in the direction from output (load side) to input (battery side) of the first switch circuit (SW1) 110 is interrupted since the first switch circuit (SW1) 110 is set in the ideal diode operating state. Therefore, occurrence of a countercurrent state where a current flows into the battery 1, 201 is prevented.

At the end, the switching process is performed such that (S106) the first switch circuit (SW1) 110=from the ideal diode operating state to the OFF state is achieved, and thus, electrical continuity between the battery 1, 201 and the load 210 is completely interrupted. Thereafter, the battery 1, 201 can be removed from the first power source port 101.

By performing the above-described processes, a regenerative energy (a regenerative current) generated by the motor of the load 210 flows into the battery 1, 201 through the first switch circuit (SW1) 110, and a charging process for the battery 1, 201 is performed.

(Step S121)

Next, a description will be made regarding a process in Steps S121 to S123.

The process in Steps S121 to S123 is a charging process for the battery 1, 201, that is, a process of charging the battery 1, 201 with a regenerative energy (a regenerative current) generated by the motor of the load 210.

This battery regeneration process is performed in a case where it is determined in Step S102 and Step S103 that the following two expressions are true.

Vin1+Vtha<Vout

Vin1+Vthb≥Vin2

In other words, the battery regeneration process is performed in a case where the following conditions are satisfied:

a value given by adding the threshold value Vtha to Vin1: the input-side voltage of the first switch circuit (SW1) 110 (=the output voltage of the battery 1, 201) is less than

Vout: the output-side voltage of each of the switch circuits 110 and 120; and a value given by adding the threshold value Vthb to

Vin1: the input-side voltage of the first switch circuit (SW1) 110 (=the output voltage of the battery 1, 201) is equal to or more than

Vin2: the input-side voltage of the second switch circuit (SW2) 120 (=the output voltage of the battery 2,

It should be noted that the FET controller 130 confirms in Steps S102 and S103 that the two expressions

Vin1+Vtha<Vout

Vin1+Vthb z Vin2

are true, determines that a rise in the load-side voltage (Vout) is based on generation of a regenerative energy, and then performs the process in Step S121 and subsequent steps, that is, the process of charging the battery 1, 201 with the regenerative energy (the regenerative current) generated by the motor of the load 210.

In other words, in a case where the expression

Vin1+Vtha<Vout

is satisfied in Step S102,

a cause for a rise in the load-side voltage (Vout) is supposed to be one of the following two reasons.

(Reason 1) a rise in voltage (Vout) based on the output voltage of the battery 2, 202

(Reason 2) a rise in the voltage (Vout) based on generation of the regenerative energy of the load 210

Then, it is further confirmed in Step S103 that the following expression is satisfied.

Vin1+Vthb≥Vin2

This expression is satisfied in a case where

the input-side voltage of the second switch circuit (SW2) 120 (=the output voltage of the battery 2, 202) is lower than

the input-side voltage of the first switch circuit (SW1) 110 (=the output voltage of the battery 1, 102)+the threshold value (Vthb).

If it is confirmed in Step S103 that the expression

Vin1+Vthb≥Vin2

is satisfied, then it is determined that the above-described (Reason 1), which is supposed to be the cause for the rise in the load-side voltage (Vout), is not a possible cause. As a result, it can be determined that

the cause for the rise in the load-side voltage (Vout) is the above-described (Reason 2), that is, a rise in the voltage (Vout) based on generation of the regenerative energy of the load 210.

In such a manner, the FET controller 130 confirms in Steps S102 and S103 that the two expressions

Vin1+Vtha<Vout

Vin1+Vthb≥Vin2

are true, and determines that a rise in the load-side voltage (Vout) is based on generation of a regenerative energy. Then, the FET controller 130 performs the process in Steps S121 to S123, that is, the process of charging the battery 1, 201 with the regenerative energy (the regenerative current) generated by the motor of the load 210.

First, in Step S121, the FET controller 130 maintains the ON state of the first switch circuit (SW1) 110.

This state maintenance process is performed as a result of the gate voltage control performed by the FET controller 130 on the two FETs of the first switch circuit (SW1) 110, that is, the FET (1A) 111 and the FET (1B) 112, so as to maintain the continuity/interruption state of each of the FETs at a present state.

(Step S122)

Next, the FET controller 130 maintains the OFF state of the second switch circuit (SW2) 120 in Step S122.

This state maintenance process is likewise performed as a result of the gate voltage control performed by the FET controller 130 on the two FETs of the second switch circuit (SW2) 120, that is, the FET (2A) 121 and the FET (2B) 122, so as to maintain the continuity/interruption state of each of the FETs at a present state.

(Step S123)

In Step S123, as a result of the above-described process in Steps S121 to S122, the charging process for the battery 1, 201, that is, the process of charging the battery 1, 201 with the regenerative energy (the regenerative current) generated by the motor of the load 210, is performed.

This charging (regeneration) process for the battery 1, 201 is a process performed when the FET controller 130 sets the respective switch circuits in the following operating states.

first switch circuit (SW1) 110=ON

second switch circuit (SW2) 120=OFF

The above settings allow a regenerative energy (a regenerative current) generated by the motor of the load 210 to flow into the battery 1, 201 through the first switch circuit (SW1) 110, so that the charging process for the battery 1, 201 is performed.

As described above, in the power source switching apparatus 100a illustrated in FIG. 8, the FET controller 130 controls the switch circuits 110 and 120 connected to the batteries 201 and 202, respectively, that is, performs a switching control between the following three states.

(a) the ON state

(b) the OFF state

(c) the ideal diode operating state

These controls performed by the FET controller 130 allow the power source switching apparatus 100a illustrated in FIG. 8 to reliably perform the following three processes.

(Process 1) normal process: a process of supplying electric power from the battery to the load

(Process 2) live-line plugging/unplugging process (hot swap): a battery switching process performed while electric power continues to be supplied to the load

(Process 3) regeneration process: a process of charging the battery by supplying the battery with a regenerative energy (a regenerative current) resulting from the rotation of the motor of the load

### 4. Process Sequence for a Case where an Initial State is Different

Next, a description will be made regarding a process sequence for a case where an initial state is different from that in the process previously described with reference to FIG. 8.

In the flow illustrated in FIG. 9, the initial state (the start state) is a normal process state where electric power is supplied from the battery 1, 201 to the load 210 through the first switch circuit (SW1) 110 in the configuration illustrated in FIG. 8

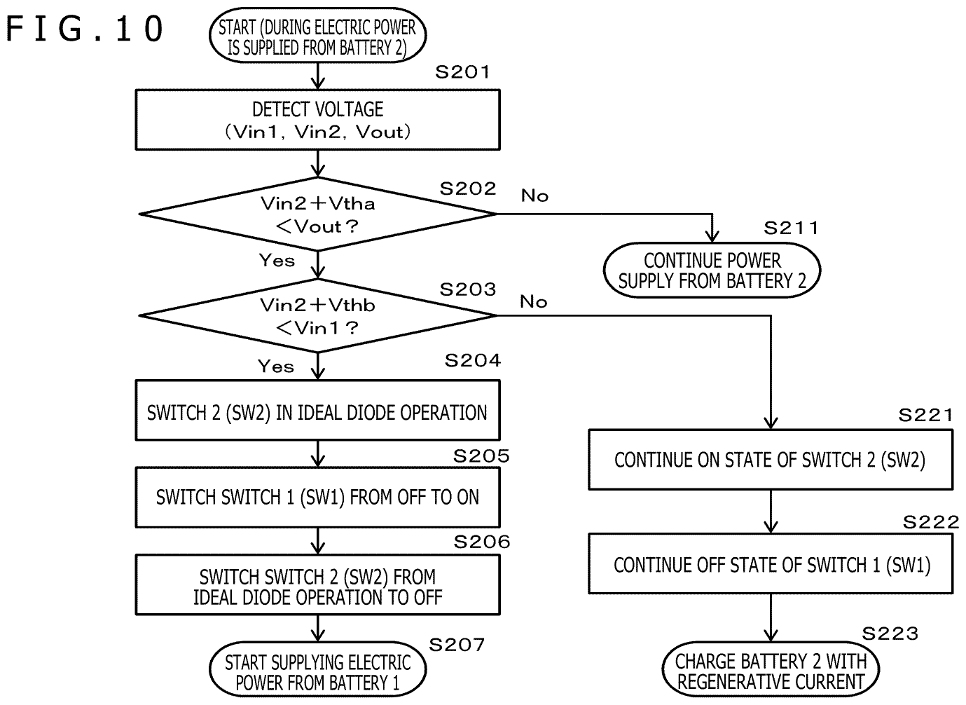

FIG. 10 illustrates a process sequence to be performed by the FET controller 130 in a case where the initial state (the start state) is a normal process state where electric power is supplied from the battery 2, 202 to the load 210 through the second switch circuit (SW2) 120.

The flow illustrated in FIG. 10 corresponds to a flow where the following elements in the flow illustrated in FIG. 9 are replaced with each other:
the battery 1 and the battery 2;
the switch 1 (SW1) and the switch 2 (SW2); and Vin1 and Vin2.

A description will be made regarding a process based on the flow illustrated in FIG. 10.

In the initial state, as a result of a gate voltage control performed on the FETs of each switch by the FET controller 130, the following state is set.

first switch circuit (SW1) 110=OFF

second switch circuit (SW2) 120=ON

(Step S201)

First, in Step S201, the FET controller 130 detects the following three voltages.

(1) Vin1: the input-side voltage of the first switch circuit (SW1) 110 (=the output voltage of the battery 1, 201)

(2) Vin2: the input-side voltage of the second switch circuit (SW2) 120 (=the output voltage of the battery 2, 202)

(3) Vout: the output-side voltage of each of the switch circuits 110 and 120

(Step S202)

Next, in Step S202, the FET controller 130 performs a process of comparing Vin1 and Vout, determining whether or not the following expression is true.

Vin2+Vtha<Vout

The process proceeds to Step S203 in a case where it is determined in Step S202 that the following expression is true.

Vin2+Vtha<Vout

In contrast, in a case where it is determined that the above expression is not true, the process proceeds to Step S211.

(Step S211)

First, a description will be made regarding a process in Step S211 for the case where the expression

Vin2+Vtha<Vout

is determined to be not true in Step S202.

Vin2+Vtha<Vout

In the case where the above expression is not true, the following relation is satisfied.

Vin2+Vtha≥Vout

In other words,

a value given by adding the threshold value Vtha to Vin2: the input-side voltage of the second switch circuit (SW2) 120 (=the output voltage of the battery 2, 202) is equal to or more than

Vout: the output-side voltage of each of the switch circuits 110 and 120.

In this case, in Step S211, a present operating state, that is, the normal process state where electric power is supplied from the battery 2, 202 to the load 210 through the second switch circuit (SW2) 120, is continued.

The process of supplying electric power from the battery 2, 202 to the load 210 is a process performed when the FET controller 130 sets (maintains) the respective switch circuits in the following operating states.

first switch circuit (SW1) 110=OFF

second switch circuit (SW2) 120=ON

As a result of the above settings, the electric power continues to be supplied from the battery 2, 202 to the load 210 through the second switch circuit (SW2) 120 which is set in the ON state.

(Step S203)

In contrast, in the case where it is determined in Step S202 that the expression

Vin2+Vtha<Vout

is true, the process proceeds to Step S203.

In Step S203, the FET controller 130 performs a process of comparing Vin1 and Vin2, determining whether or not the following expression is true.

Vin2+Vthb<Vin2

The process proceeds to Step S204 in a case where it is determined in Step S203 that the following expression is true.

Vin2+Vthb<Vin1

In contrast, in a case where it is determined that the above expression is not true, the process proceeds to Step S221.

It should be noted that, in the case where the expression

Vin2+Vthb<Vin1

is true in Step S203, the battery 1, 201, which is higher in voltage than the battery 2, 202, is connected to the input-side first power source port 101 of the first switch circuit (SW1) 110. In other words, an unused battery for replacement is connected to the input-side first power source port 101.

Thus, the determination process in Step S203 corresponds to a process of determining whether or not the new and unused battery 1, 201 for replacement is connected to the input-side first power source port 101 of the first switch circuit (SW1) 110.

In the case where the expression

Vin2+Vthb<Vin1

is true in Step S203, the unused battery 1, 201 for replacement is determined to be connected to the input-side first power source port 101 of the first switch circuit (SW1) 110, and, in Step S204 and subsequent steps, a live-line plugging/unplugging (hot swapping) process for a battery is performed.

In contrast, in the case where the above expression is determined to be not true, the unused battery 1, 201 for replacement is determined to be not connected to the input-side first power source port 101 of the first switch circuit (SW1) 110, and, in Step S221 and subsequent steps, a charging process for the battery 2, 202, that is, a process of charging the battery 2, 202 with a regenerative energy (a regenerative current) generated by the motor of the load 210, is performed.

(Step S204)

The process in Steps S204 to S207 corresponds to the live-line plugging/unplugging (hot swapping) process for a battery.

This live-line plugging/unplugging (hot swapping) process for a battery in Steps S204 to S207 is performed in a case where it is determined in Step S202 and Step S203 that the following two expressions are true.

Vin1+Vtha<Vout

Vin1+Vthb<Vin2

First, in Step S204, the FET controller 130 changes the second switch circuit (SW2) 120 from the ON state to the ideal diode operating state.

This state change process is performed as a result of the gate voltage control performed by the FET controller 130 on the two FETs of the second switch circuit (SW2) 120, that is, the FET (2A) 121 and the FET (2B) 122, so as to switch the continuity/interruption state of each of the FETs.

(Step S205)

Next, in Step S205, the FET controller 130 changes the first switch circuit (SW1) 110 from the OFF state to the ON state.

This state change process is likewise performed as a result of the gate voltage control performed by the FET controller 130 on the two FETs of the first switch circuit (SW1) 110, that is, the FET (1A) 111 and the FET (1B) 112, so as to switch the continuity/interruption state of each of the FETs.

(Step S206)

Next, in Step S206, the FET controller 130 changes the second switch circuit (SW2) 120 from the ideal diode operating state to the OFF state.

This state change process is likewise performed as a result of the gate voltage control performed by the FET controller 130 on the two FETs of the second switch circuit (SW2) 120, that is, the FET (2A) 121 and the FET (2B) 122, so as to switch the continuity/interruption state of each of the FETs.

(Step S207)

In Step S207, as a result of the above-described process in Steps S204 to S206, electric power starts being supplied from the battery 1, 201 to the load 210 through the first switch circuit (SW1) 110.

In other words,

a process of a change from

a start state=a state where electric power is supplied from the battery 2, 202 to the load 210 through the second switch circuit (SW2) 120, to

Step S207=a state where electric power is supplied from the battery 1, 201 to the load 210 through the first switch circuit (SW1) 110

is performed without stopping the electric power being supplied to the load 210.

That is, the live-line plugging/unplugging (hot swapping) process for a battery is completed.

(Step S221)

Next, a description will be made regarding a process in Steps S221 to S223.

The process in Steps S221 to S223 is a charging process for the battery 2, 202, that is, a process of charging the battery 2, 202 with a regenerative energy (a regenerative current) generated by the motor of the load 210.

This battery regeneration process is performed in a case where it is determined in Step S202 and Step S203 that the following two expressions are true.

Vin2+Vtha<Vout

Vin2+Vthb≥Vin1

The FET controller 130 confirms in Steps S202 and S203 that the two expressions

Vin2+Vtha<Vout

Vin2+Vthb≥Vin1

are true, determines that a rise in the load-side voltage (Vout) is based on generation of a regenerative energy, and then performs the process in Step 3221 and subsequent steps, that is, the process of charging the battery 2, 202 with the regenerative energy (the regenerative current) generated by the motor of the load 210.

First, in Step S221, the FET controller 130 maintains the ON state of the second switch circuit (SW2) 120.

This state maintenance process is performed as a result of the gate voltage control performed by the FET controller 130 on the two FETs of the second switch circuit (SW2) 120, that is, the FET (2A) 121 and the FET (2B) 122, so as to maintain the continuity/interruption state of each of the FETs at a present state.

(Step S222)

Next, the FET controller 130 maintains the OFF state of the first switch circuit (SW1) 110 in Step S222.

This state maintenance process is likewise performed as a result of the gate voltage control performed by the FET controller 130 on the two FETs of the first switch circuit (SW1) 110, that is, the FET (1A) 111 and the FET (1B) 112, so as to maintain the continuity/interruption state of each of the FETs at a present state.

(Step S223)

In Step S223, as a result of the above-described process in Steps S221 to S222, the charging process for the battery 2, 202, that is, the process of charging the battery 2, 202 with the regenerative energy (the regenerative current) generated by the motor of the load 210, is performed.

As described above, irrespective of whether the initial state is the state where electric power is supplied to the load 210 through the battery 1, 201 or the state where electric power is supplied to the load 210 through the battery 2, 202, the power source switching apparatus 100a illustrated in FIG. 8 performs, in either case, a control of the switch circuits 110 and 120, that is, a control of the following three states.

(a) an ON state

(b) an OFF state

(c) an ideal diode operating state

This makes it possible to reliably perform the following three processes.

(Process 1) normal process: a process of supplying electric power from the battery to the load

(Process 2) live-line plugging/unplugging process (hot swap): a battery switching process performed while electric power continues to be supplied to the load

(Process 3) regeneration process: a process of charging the battery by supplying the battery with a regenerative energy (a regenerative current) resulting from the rotation of the motor of the load

### 5. Other Embodiments

Next, a description will be made regarding other embodiments.

The power source switching apparatus 100a illustrated in FIG. 8 is a configuration example of the power source switching apparatus of the present disclosure, The power source switching apparatus of the present disclosure can be implemented by a variety of configurations in addition to the configuration illustrated in FIG. 8.

A plurality of modification examples will be described in sequence as follow.

Modification example 1. Configuration example with separate FET controllers corresponding one-to-one to the switch circuits

Modification example 2. Configuration example with a microcomputer (MCU)

Modification example 3. Configuration example with a comparator

Modification example 4. Configuration example with a CPU

### Modification Example 1. Configuration Example with Separate FET Controllers Corresponding One-to-One to the Switch Circuits

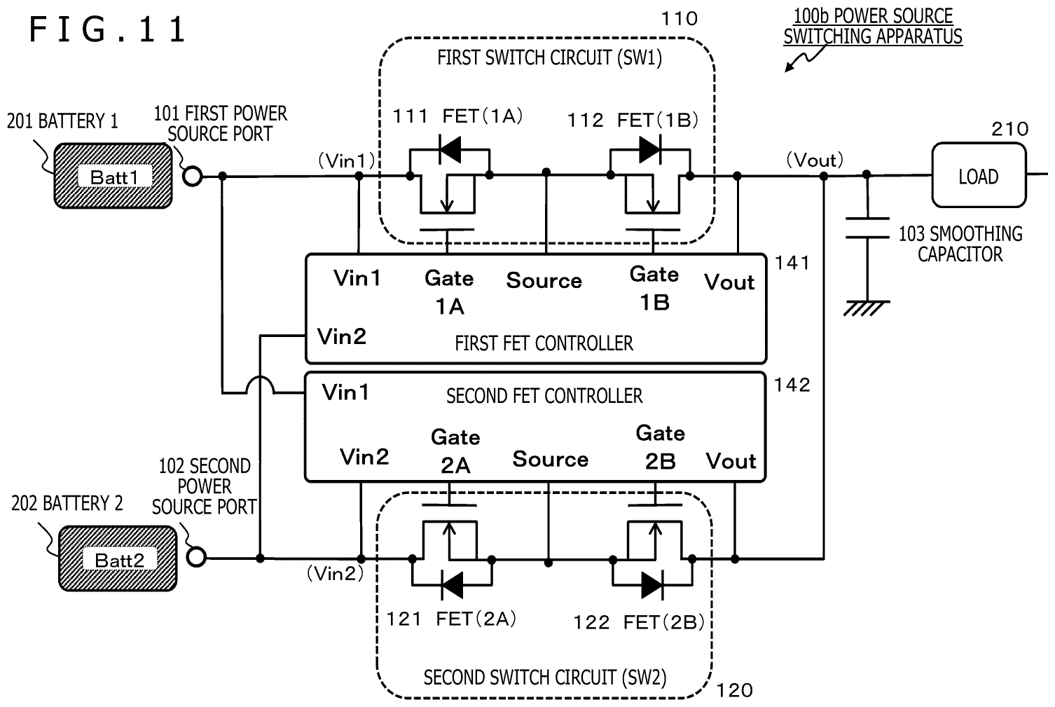

First, a description will be made regarding, as a modification example 1, a configuration example with separate FET controllers corresponding one-to-one to the switch circuits, with reference to FIG. 11.

A power source switching apparatus 100b illustrated in FIG. 11 is a power source switching apparatus having a configuration where the FET controller 130 of the power source switching apparatus 100a illustrated in FIG. 8 is divided into two.

The power source switching apparatus 100b illustrated in FIG. 11 includes a first FET controller 141 and a second FET controller 142.

The first FET controller 141 controls the two FETs of the first switch circuit (SW1), i.e., the FET (1A) 111 and the FET (1B) 112. The first FET controller 141 controls a gate-source voltage of each of the FETs

Similarly, the second FET controller 142 controls the two FETs of the second switch circuit (SW2), i.e., the FET (2A) 121 and the FET (2B) 122. The second FET controller 142 controls a gate-source voltage of each of the FETs

As a result of the control performed by the first FET controller 141 and the second FET controller 142, the first switch circuit (SW1) and the second switch circuit (SW2) are each set in any one of the following three states.

(a) the ON state

(b) the OFF state

(c) the ideal diode operating state

The power source switching apparatus 100b illustrated in FIG. 11 can also perform processes similar to the previously described processes based on the flows illustrated in FIG. 9 and FIG. 10.

### Modification Example 2. Configuration Example with a Microcomputer (MCU)

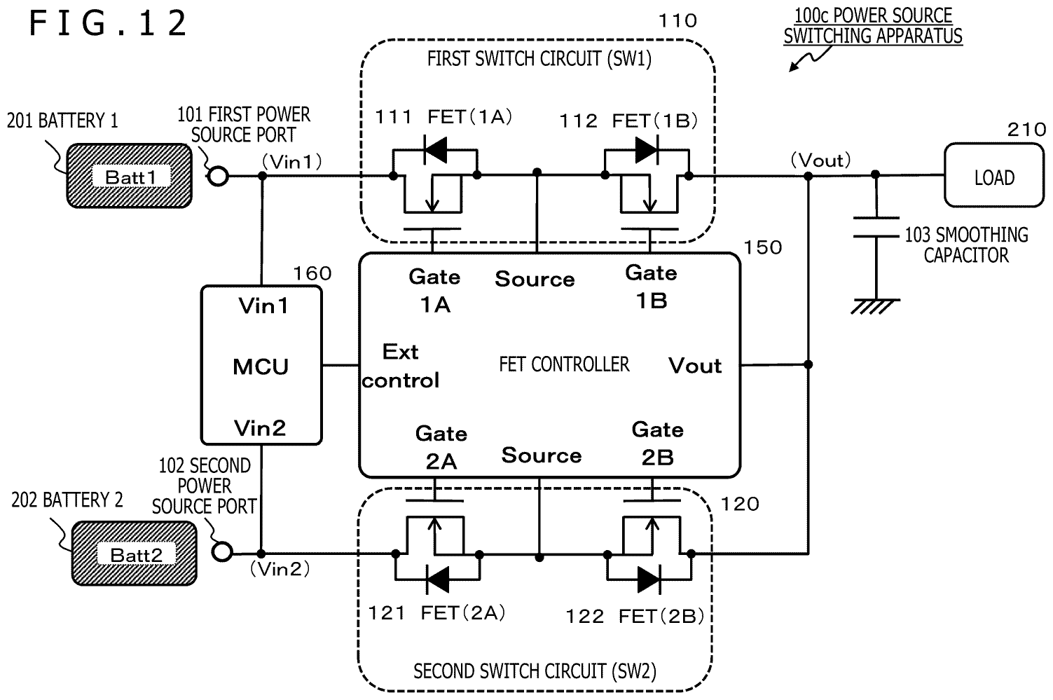

Next, a description will be made regarding a configuration example with a microcomputer (MCU), with reference to FIG. 12.

A power source switching apparatus 100c illustrated in FIG. 12 is a power source switching apparatus having a configuration where the FET controller 130 of the power source switching apparatus 100a illustrated in FIG. 8 is divided into two components, i.e., an FET controller 150 and a microcomputer (MCU) 160 illustrated in FIG. 12.

The FET controller 130 of the power source switching apparatus 100a illustrated in FIG. 8 performs, within the FET controller 130, the process of comparing the voltages (Vin1, Vin2, and Vout), determination of a control mode based on the comparison result, etc.

In contrast, in the power source switching apparatus 100c illustrated in FIG. 12, the microcomputer (MCU) 160 performs a process of comparing the input-side voltage (Vin1) of the first switch circuit (SW1) 110, i.e., a battery 1, 101-side voltage, and the input-side voltage (Vin2) of the second switch circuit (SW2) 120, i.e., a battery 2, 102-side voltage. The FET controller 150 controls the FETs of each of the switch circuits 110 and 120 on the basis of a voltage comparison result outputted from the microcomputer (MCU) 160.

The FET controller 150 includes a control information input unit (an Exit control terminal) that receives, as input, the voltage comparison result outputted from the microcomputer (MCU) 160, and controls the FETs of each of the switch circuits 110 and 120 on the basis of an outputted value from the microcomputer (MCU) 160 that is received as input through the control information input unit (the Exit control terminal).

In a case of this configuration, the processes based on the flows illustrated in FIG. 9 and FIG. 10 are to be performed by the microcomputer (MCU) 160 and the FET controller 150.

It should be noted that the microcomputer (MCU) 160 may determine the control mode of each of the switches on the basis of the voltage comparison result, and input determined control information to the FET controller 1250.

In this case, the FET controller 150 performs a control according to the control information received as input from the microcomputer 160.

### Modification Example 3. Configuration Example with a Comparator

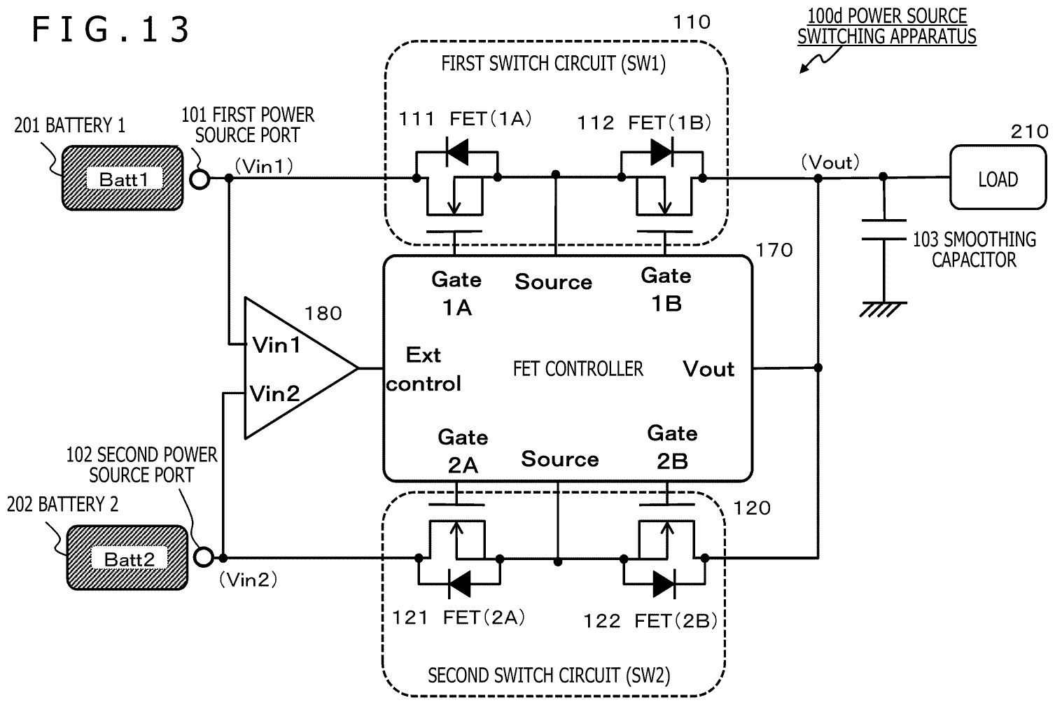

Next, a description will be made regarding a configuration example with a comparator, with reference to FIG. 13.

A power source switching apparatus 100d illustrated in FIG. 13 has a configuration where the FET controller 130 of the power source switching apparatus 100a illustrated in FIG. 8 is divided into two components, i.e., an FET controller 170 and a comparator 180 illustrated in FIG. 13.

The comparator 180 of the power source switching apparatus 100d illustrated in FIG. 13 performs a process of comparing the input-side voltage (Vin1) of the first switch circuit (SW1) 110, i.e., the battery 1, 101-side voltage, and the input-side voltage (Vin2) of the second switch circuit (SW2) 120, i.e., the battery 2, 102-side voltage, and inputs a comparison result to the FET controller 170.

The FET controller 170 includes an information input unit (an Exit control terminal) that receives, as input, the voltage comparison result from the comparator 180, and controls the FETs of each of the switch circuits 110 and 120 on the basis of the voltage comparison result received as input through the information input unit (the Exit control terminal).

In a case of this configuration, the processes based on the flows illustrated in FIG. 9 and FIG. 10 are to be performed by the comparator 180 and the FET controller 170.

### Modification Example 4. Configuration Example with a CPU

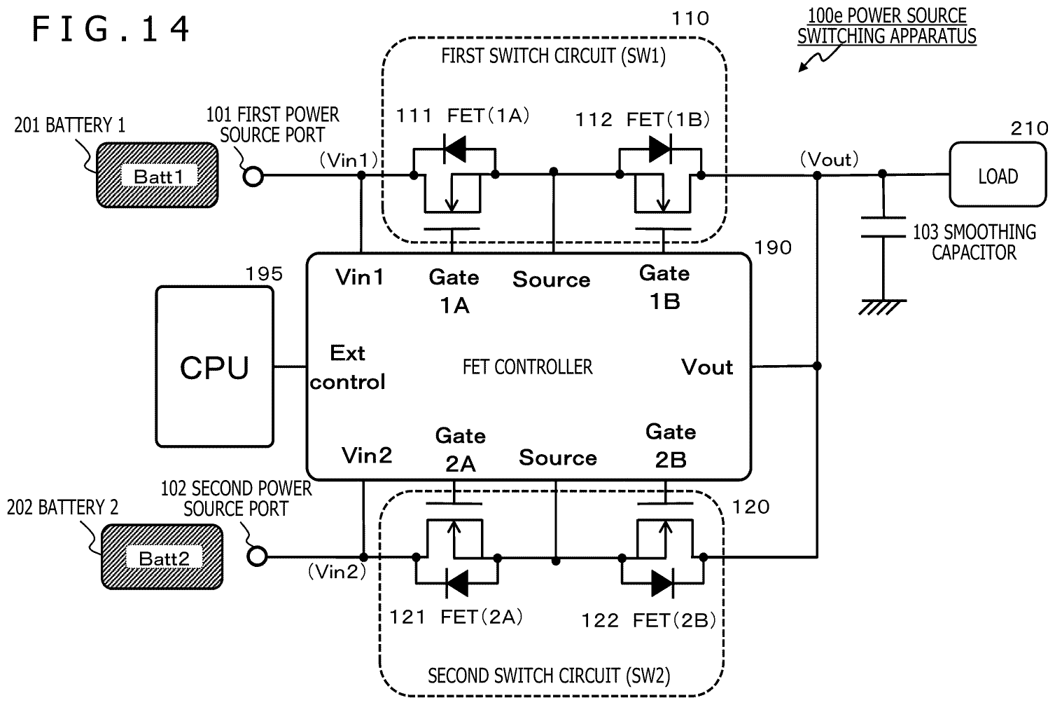

Next, a description will be made regarding a configuration example with a CPU, with reference to FIG. 14.

A power source switching apparatus 100e illustrated in FIG. 14 has a configuration where the FET controller 130 of the power source switching apparatus 100a illustrated in FIG. 8 is divided into two components, i.e., an FET controller 190 and a CPU 195 illustrated in FIG. 14.

The CPU 195 controls a timing of switching the operating state (ON, OFF, or ideal diode) of each of the switch circuits on the basis of, for example, an operating state of a load.

Specifically, the CPU 195 selects a timing at which the load 210 has a less operating amount, and performs a control for causing the operating state (ON, OFF, or ideal diode) of each of the switch circuits to be switched.

The CPU 195 acquires an operation plan of the load, specifically, action plan information regarding a robot (program information), from a storage unit not illustrated and detects a timing at which the load 210 has a less processing amount, on the basis of the acquired action plan information (the program information). Control information is outputted to the FET controller 190 such that switching of the operating state (ON, OFF, or ideal diode) of each of the switch circuits is performed at the detected timing.

It should be noted that the CPU 195 may perform a process of monitoring a load operating status, detect a timing at which the load 210 has a less processing amount, on the basis of a monitoring result, and output the control information to the FET controller 190 such that switching of the operating state (ON, OFF, or ideal diode) of each of the switch circuits is performed at the detected timing.

By performing such a control, it is possible to perform the switch state switching process in which a stress on the FETs of each of the switch circuits is reduced.

### 6. Hardware Configuration Example of a Robot

Next, a description will be made regarding an example of a hardware configuration of a traveling robot 300 including the above-described power source switching circuit therein.

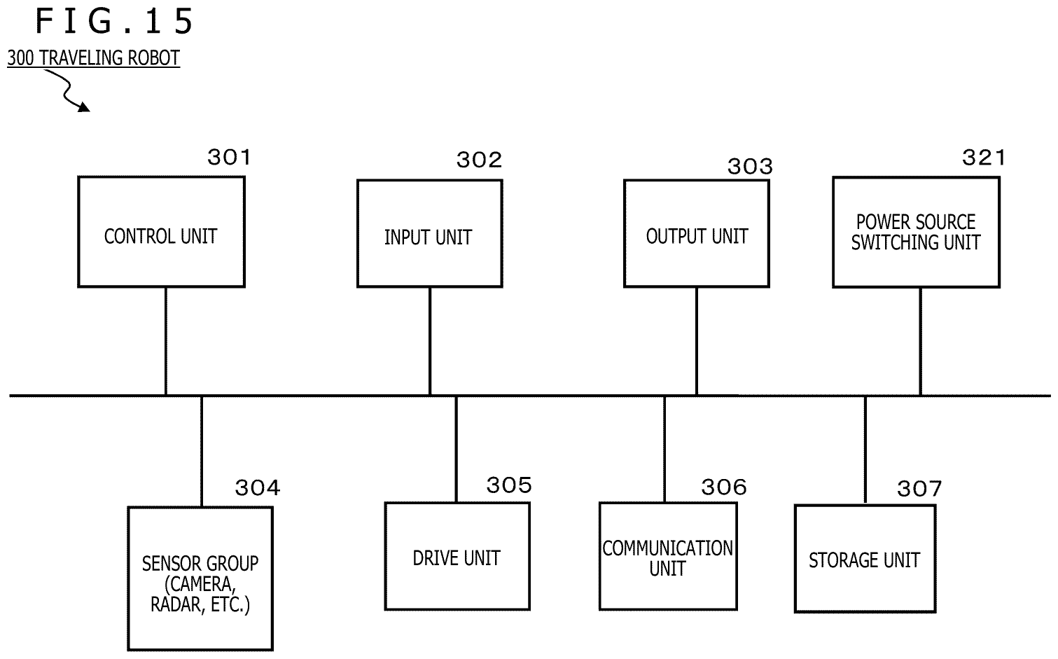

FIG. 15 is a block diagram illustrating a configuration example of the traveling robot 300 of the present disclosure.

As illustrated in FIG. 15, the traveling robot 300 includes a control unit 301, an input unit 302, an output unit 303, a sensor group 304, a drive unit 305, a communication unit 306, a storage unit 307, and a power source switching unit 321.

The control unit 301 performs a control for a process performed in the traveling robot 100. For example, the control unit 301 performs a process according to a control program stored in the storage unit 307. The control unit 301 includes a processor having a program execution function.

The input unit 302 is an interface to which various pieces of data can be inputted by a user, and includes a touch panel, a code reader unit, a variety of switches, etc.

The output unit 303 is a speaker that outputs an alert or a voice, a display that outputs an image, and an output unit that outputs light or the like.

The sensor group 304 includes a variety of sensors such as a camera, a microphone, a radar, and a range sensor.

The drive unit 305 includes an actuator such as a motor, which serves as a drive unit for a wheel or a leg for causing the traveling robot 100 to move, a direction control mechanism, etc.

The communication unit 306 performs a process of communication with, for example, a management server, an external device such as an external sensor, etc.

The storage unit 307 stores travel route information, information regarding a program to be performed in the control unit 301, etc.

The power source switching unit 321 has a configuration corresponding to the power source switching apparatus previously described with reference to FIG. 8, etc. In other words, the power source switching unit 321 has a configuration that, by switching the operating states (ON, OFF, or ideal diode operation) of the switch circuits, achieves the following processes.

(a) the live-line plugging/unplugging (hot swap) process for a battery

(b) the recovery of a regenerative energy

### 7. Summary of Configurations of the Present Disclosure

The embodiments of the present disclosure are described in detail above with reference to the specific embodiments. However, it is obvious that those skilled in the art would alter or replace the embodiments without departing from the scope of the spirit of the present disclosure. In other words, the present invention is disclosed by way of example and should not be understood as limitations. In order to determine the spirit of the present disclosure, the claims should be taken into account.

It should be noted that the technology disclosed herein can be take the following configurations.

(1)

A power source switching apparatus including:

a first switch circuit provided between a first power source port and a load to be supplied with electric power;

a second switch circuit provided between a second power source port and the load; and

a controller configured to control the first switch circuit and the second switch circuit, in which the controller is configured to perform, on each of the first switch circuit and the second switch circuit, a process of switching between three states including
(a) an ON state that indicates a continuity state,
(b) an OFF state that indicates an interruption state, and
(c) a diode operating state where the electric power is allowed to be supplied only in one direction from a power source port side toward a load side in a case where a power-source-port-side voltage is higher than a load-side voltage,

thereby performing a process of switching between power sources individually connected to the first power source port and second power source port without stopping the electric power being supplied to the load.

(2)

The power source switching apparatus according to (1), in which

the controller is configured to perform a process of charging a battery that is used as a power source and connected to the first power source port or the second power source port, by inputting, to the battery, a regenerative energy generated by a rotation of a motor included in the load.

(3)

The power source switching apparatus according to (1) or (2), in which

the controller compares
a first switch circuit input-side voltage (Vin1) that is included in a voltage of the first switch circuit on a side of the first power source port,
a second switch circuit input-side voltage (Vin2) that is included in a voltage of the second switch circuit on a side of the second power source port, and
a switch circuit output-side voltage (Vout) that is included in a voltage of the first switch circuit and the second switch circuit on a side of the load, and

the controller performs the process of switching between the three states according to a comparison result.

(4)

The power source switching apparatus according to (3), in which

the controller is configured to determine, on the basis of the comparison result of
the first switch circuit input-side voltage (Vin1),
the second switch circuit input-side voltage (Vin2), and
the switch circuit output-side voltage (Vout),

whether a battery replacement execution mode is on or a charging mode is on,

the battery replacement execution mode being a mode in which the first power source port and the second power source port are both connected to the respective power sources,

the charging mode being a mode in which the process of charging the battery that is used as a power source and connected to the first power source port or the second power source port, by inputting, to the battery, the regenerative energy generated by the rotation of the motor included in the load is performed.

(5)

The power source switching apparatus according to any one of (1) to (4), in which

the first switch circuit and the second switch circuit each include an ideal diode circuit having a plurality of FETs.

(6)

The power source switching apparatus according to any one of (1) to (5), in which

the controller is configured to control a gate-source voltage of each of the FETs provided in the first switch circuit and the second switch circuit.

(7)

The power source switching apparatus according to any one of (1) to (6), in which

the controller includes a plurality of controllers, the plurality of controllers including
a first controller configured to perform a control of the first switch circuit, and
a second controller configured to perform a control of the second switch circuit.
   (8)

The power source switching apparatus according to any one of (1) to (7), further including:

a microcomputer connected to the controller, the microcomputer being configured to

perform a process of comparing
a first switch circuit input-side voltage (Vin1) that is included in a voltage of the first switch circuit on a side of the first power source port, and
a second switch circuit input-side voltage (Vin2) that is included in a voltage of the second switch circuit on a side of the second power source port, and

output a comparison result to the controller.

(9)

The power source switching apparatus according to any one of (1) to (8), further including:

a comparator connected to the controller, the comparator being configured to

perform a process of comparing
a first switch circuit input-side voltage (Vin1) that is included in a voltage of the first switch circuit on a side of the first power source port, and
a second switch circuit input-side voltage (Vin2) that is included in a voltage of the second switch circuit on a side of the second power source port, and

output a comparison result to the controller.

(10)

The power source switching apparatus according to any one of (1) to (9), further including:

a processor connected to the controller, the processor being configured to control a timing of the process of switching between the three states (a) to (c).

(11)

The power source switching apparatus according to any one of (1) to (10), in which

the processor is configured to determine a timing of the process of switching between the three states (a) to (c), according to a processing status of the load.

(12)

A robot including:

a load including a drive unit; and

a power source switching unit configured to perform a control of switching between power sources that supply electric power to the load, in which

the power source switching unit includes
a first switch circuit provided between a first power source port and the load to be supplied with the electric power,
a second switch circuit provided between a second power source port and the load, and
a controller configured to control the first switch circuit and the second switch circuit, and

the controller is configured to perform, on each of the first switch circuit and the second switch circuit, a process of switching between three states including
(a) an ON state that indicates a continuity state,
(b) an OFF state that indicates an interruption state, and
(c) a diode operating state where the electric power is allowed to be supplied only in one direction from a power source port side toward a load side in a case where a power-source-port-side voltage is higher than a load-side voltage,

thereby performing a process of switching between the power sources individually connected to the first power source port and second power source port without stopping the electric power being supplied to the load.

(13)

The robot according to (12), in which

the controller is configured to perform a process of charging a battery that is used as a power source and connected to the first power source port or the second power source port, by inputting, to the battery, a regenerative energy generated by a rotation of a motor included in the load.

(14)

A power source switching control method that is performed on a power source switching apparatus, in which

the power source switching apparatus includes
a first switch circuit provided between a first power source port and a load to be supplied with electric power,
a second switch circuit provided between a second power source port and the load, and
a controller configured to control the first switch circuit and the second switch circuit, and

the controller is configured to perform, on each of the first switch circuit and the second switch circuit, a process of switching between three states including
(a) an ON state that indicates a continuity state,
(b) an OFF state that indicates an interruption state, and
(c) a diode operating state where the electric power is allowed to be supplied only in one direction from a power source port side toward a load side in a case where a power-source-port-side voltage is higher than a load-side voltage,

thereby performing a process of switching between power sources individually connected to the first power source port and second power source port without stopping the electric power being supplied to the load.

(15)

A robot control method that is performed on a robot, in which

the robot includes
a load including a drive unit, and
a power source switching unit configured to perform a control of switching between power sources that supply electric power to the load,

the power source switching unit includes
a first switch circuit provided between a first power source port and the load to be supplied with the electric power,
a second switch circuit provided between a second power source port and the load, and
a controller configured to control the first switch circuit and the second switch circuit, and

the controller is configured to perform, on each of the first switch circuit and the second switch circuit, a process of switching between three states including
(a) an ON state that indicates a continuity state,
(b) an OFF state that indicates an interruption state, and
(c) a diode operating state where the electric power is allowed to be supplied only in one direction from a power source port side toward a load side in a case where a power-source-port-side voltage is higher than a load-side voltage,

thereby performing a process of switching between the power sources individually connected to the first power source port and second power source port without stopping the electric power being supplied to the load.

(16)

A program causing a power source switching control process to be performed on a power source switching apparatus, the power source switching apparatus including

a first switch circuit provided between a first power source port and a load to be supplied with electric power,

a second switch circuit provided between a second power source port and the load, and

a controller configured to control the first switch circuit and the second switch circuit,

the program causing the controller to perform:

on each of the first switch circuit and the second switch circuit, a process of switching between three states including
(a) an ON state that indicates a continuity state,
(b) an OFF state that indicates an interruption state, and
(c) a diode operating state where the electric power is allowed to be supplied only in one direction from a power source port side toward a load side in a case where a power-source-port-side voltage is higher than a load-side voltage,

thereby performing a process of switching between power sources individually connected to the first power source port and second power source port without stopping the electric power being supplied to the load.

It should be noted that a series of processes described herein can be performed by hardware, software, or the combination of both. In a case where the processes are performed by software, a program in which a process sequence is recorded can be installed in a memory within a computer installed in dedicated hardware and be executed, or a program can be installed in a general-purpose computer capable of performing a variety of processes and be executed. For example, the program can be recorded in advance in a recording medium. In addition to being installed in a computer from the recording medium, the program can be received through a network such as a LAN (Local Area Network) or the Internet and installed in a built-in recording medium such as hard disk.

Further, the variety of processes described herein may be performed in parallel or independently depending on an ability of processing of an apparatus that performs the processes or as necessary, instead of being performed in a chronological order based on the description. Further, a system herein refers to a logical cluster configuration including a plurality of apparatuses, and the apparatuses in the configuration are not necessarily within the same casing.

### INDUSTRIAL APPLICABILITY

As described above, with the configuration of an embodiment of the present disclosure, an apparatus and a method capable of performing a power source switching process and a charging process without stopping electric power being supplied to a load are implemented.

Specifically, the configuration includes, for example, a first switch circuit provided between a first power source port and a load to be supplied with electric power, a second switch circuit provided between a second power source port and the load, and a controller configured to control each of the switch circuits. The controller is configured to perform, on each of the switch circuits, a process of switching between three states, that is, (a) an ON state, (b) an OFF state, and (c) a diode operating state, thereby performing a process of switching between power sources connected to the respective power source ports without stopping the electric power being supplied to the load. Further, the controller is configured to perform battery charging with a regenerative energy resulting from a rotation of a motor which is the load.

With the present configuration, an apparatus and a method capable of performing a power source switching process and a charging process without stopping electric power being supplied to a load are implemented.

### REFERENCE SIGNS LIST

10: Robot
11: Battery 1
12: Battery 2
21: Motor
31, 32: Ideal diode circuit
100: Power source switching apparatus
101: First power source port
102: Second power source port
103: Smoothing capacitor
110: First switch circuit (SW1)
111, 112: FET
120: Second switch circuit (SW2)
121, 122: FET
130: FET controller
201: Battery 1
202: Battery 2
210: Load
141: First FET controller
142: Second FET controller
150: FET controller
160: Microcomputer (MCU)
170: FET controller
180: Comparator
190: FET controller
195: CPU
300: Traveling robot
301: Control unit
302: Input unit
303: Output unit
304: Sensor group
305: Drive unit
306: Communication unit
307: Storage unit
321: Power source switching unit

1. A power source switching apparatus comprising:
a first switch circuit provided between a first power source port and a load to be supplied with electric power;
a second switch circuit provided between a second power source port and the load; and
a controller configured to control the first switch circuit and the second switch circuit, wherein
the controller is configured to perform, on each of the first switch circuit and the second switch circuit, a process of switching between three states including
(a) an ON state that indicates a continuity state,
(b) an OFF state that indicates an interruption state, and
(c) a diode operating state where the electric power is allowed to be supplied only in one direction from a power source port side toward a load side in a case where a power-source-port-side voltage is higher than a load-side voltage,
thereby performing a process of switching between power sources individually connected to the first power source port and second power source port without stopping the electric power being supplied to the load.

2. The power source switching apparatus according to claim 1, wherein
the controller is configured to perform a process of charging a battery that is used as a power source and connected to the first power source port or the second power source port, by inputting, to the battery, a regenerative energy generated by a rotation of a motor included in the load.

3. The power source switching apparatus according to claim 1, wherein
the controller compares
a first switch circuit input-side voltage (Vin1) that is included in a voltage of the first switch circuit on a side of the first power source port,
a second switch circuit input-side voltage (Vin2) that is included in a voltage of the second switch circuit on a side of the second power source port, and
a switch circuit output-side voltage (Vout) that is included in a voltage of the first switch circuit and the second switch circuit on a side of the load, and
the controller performs the process of switching between the three states according to a comparison result.

4. The power source switching apparatus according to claim 3, wherein
the controller is configured to determine, on a basis of the comparison result of
the first switch circuit input-side voltage (Vin1),
the second switch circuit input-side voltage (Vin2), and
the switch circuit output-side voltage (Vout),
whether a battery replacement execution mode is on or a charging mode is on,
the battery replacement execution mode being a mode in which the first power source port and the second power source port are both connected to the respective power sources,
the charging mode being a mode in which a process of charging a battery that is used as a power source and connected to the first power source port or the second power source port, by inputting, to the battery, a regenerative energy generated by a rotation of a motor included in the load is performed.

5. The power source switching apparatus according to claim 1, wherein
the first switch circuit and the second switch circuit each include an ideal diode circuit having a plurality of FETs.

6. The power source switching apparatus according to claim 1, wherein
the controller is configured to control a gate-source voltage of each of FETs provided in the first switch circuit and the second switch circuit.

7. The power source switching apparatus according to claim 1, wherein
the controller includes a plurality of controllers, the plurality of controllers including
a first controller configured to perform a control of the first switch circuit, and
a second controller configured to perform a control of the second switch circuit.

8. The power source switching apparatus according to claim 1, further comprising:
a microcomputer connected to the controller, the microcomputer being configured to perform a process of comparing
a first switch circuit input-side voltage (Vin1) that is included in a voltage of the first switch circuit on a side of the first power source port, and
a second switch circuit input-side voltage (Vin2) that is included in a voltage of the second switch circuit on a side of the second power source port, and
output a comparison result to the controller.

9. The power source switching apparatus according to claim 1, further comprising:
a comparator connected to the controller, the comparator being configured to
perform a process of comparing
a first switch circuit input-side voltage (Vin1) that is included in a voltage of the first switch circuit on a side of the first power source port, and
a second switch circuit input-side voltage (Vin2) that is included in a voltage of the second switch circuit on a side of the second power source port, and
output a comparison result to the controller.

10. The power source switching apparatus according to claim 1, further comprising:
a processor connected to the controller, the processor being configured to control a timing of the process of switching between the three states (a) to (c).

11. The power source switching apparatus according to claim 1, wherein
the processor is configured to determine a timing of the process of switching between the three states (a) to (c), according to a processing status of the load.

12. A robot comprising:
a load including a drive unit; and
a power source switching unit configured to perform a control of switching between power sources that supply electric power to the load, wherein
the power source switching unit includes
a first switch circuit provided between a first power source port and the load to be supplied with the electric power,
a second switch circuit provided between a second power source port and the load, and
a controller configured to control the first switch circuit and the second switch circuit, and
the controller is configured to perform, on each of the first switch circuit and the second switch circuit, a process of switching between three states including
(a) an ON state that indicates a continuity state,
(b) an OFF state that indicates an interruption state, and
(c) a diode operating state where the electric power is allowed to be supplied only in one direction from a power source port side toward a load side in a case where a power-source-port-side voltage is higher than a load-side voltage,
thereby performing a process of switching between the power sources individually connected to the first power source port and second power source port without stopping the electric power being supplied to the load.

13. The robot according to claim 12, wherein
the controller is configured to perform a process of charging a battery that is used as a power source and connected to the first power source port or the second power source port, by inputting, to the battery, a regenerative energy generated by a rotation of a motor included in the load.

14. A power source switching control method that is performed on a power source switching apparatus, wherein
the power source switching apparatus includes
a first switch circuit provided between a first power source port and a load to be supplied with electric power,
a second switch circuit provided between a second power source port and the load, and
a controller configured to control the first switch circuit and the second switch circuit, and
the controller is configured to perform, on each of the first switch circuit and the second switch circuit, a process of switching between three states including
(a) an ON state that indicates a continuity state,
(b) an OFF state that indicates an interruption state, and
(c) a diode operating state where the electric power is allowed to be supplied only in one direction from a power source port side toward a load side in a case where a power-source-port-side voltage is higher than a load-side voltage,
thereby performing a process of switching between power sources individually connected to the first power source port and second power source port without stopping the electric power being supplied to the load.

15. A robot control method that is performed on a robot, wherein
the robot includes
a load including a drive unit, and
a power source switching unit configured to perform a control of switching between power sources that supply electric power to the load,
the power source switching unit includes
a first switch circuit provided between a first power source port and the load to be supplied with the electric power,
a second switch circuit provided between a second power source port and the load, and
a controller configured to control the first switch circuit and the second switch circuit, and
the controller is configured to perform, on each of the first switch circuit and the second switch circuit, a process of switching between three states including
(a) an ON state that indicates a continuity state,
(b) an OFF state that indicates an interruption state, and
(c) a diode operating state where the electric power is allowed to be supplied only in one direction from a power source port side toward a load side in a case where a power-source-port-side voltage is higher than a load-side voltage,
thereby performing a process of switching between the power sources individually connected to the first power source port and second power source port without stopping the electric power being supplied to the load.

16. A program causing a power source switching control process to be performed on a power source switching apparatus, the power source switching apparatus including
a first switch circuit provided between a first power source port and a load to be supplied with electric power,
a second switch circuit provided between a second power source port and the load, and
a controller configured to control the first switch circuit and the second switch circuit,
the program causing the controller to perform:
on each of the first switch circuit and the second switch circuit, a process of switching between three states including
(a) an ON state that indicates a continuity state,
(b) an OFF state that indicates an interruption state, and
(c) a diode operating state where the electric power is allowed to be supplied only in one direction from a power source port side toward a load side in a case where a power-source-port-side voltage is higher than a load-side voltage,
thereby performing a process of switching between power sources individually connected to the first power source port and second power source port without stopping the electric power being supplied to the load.
